(19) United States
(12) Patent Application Publication
(10) Pub. No.: US 2025/0039883 A1
(43) Pub. Date: Jan. 30, 2025

(54) DATA TRANSMISSION METHOD AND APPARATUS, COMPUTER DEVICE, AND STORAGE MEDIUM

(71) Applicant: GUANGDONG OPPO MOBILE TELECOMMUNICATIONS CORP., LTD., Dongguan (CN)

(72) Inventors: Zhe FU, Dongguan (CN); Yanan LIN, Dongguan (CN); Cong SHI, Dongguan (CN)

(21) Appl. No.: 18/917,268

(22) Filed: Oct. 16, 2024

Related U.S. Application Data
(63) Continuation of application No. PCT/CN2022/090517, filed on Apr. 29, 2022.

(51) Int. Cl. H04W 72/21; H04W 72/0446; H04W 72/1268

(52) U.S. Cl. CPC H04W 72/21; H04W 72/0446; H04W 72/1268

(57) ABSTRACT

This application relates to a data transmission method and apparatus, a computer device, and a storage medium. A first device (01) sends indication information to a second device (02), so that the first device (01) informs the second device (02) of a usage status of a target resource in time, and after receiving the indication information, the second device (02) may determine, based on the indication information, which resources to use, which resources to receive or decode, which resources not to receive or decode, which resources to terminate, and the like.

### CROSS-REFERENCE TO RELATED APPLICATIONS

This application is a continuation of International Application No. PCT/CN2022/090517, filed on Apr. 29, 2022, the disclosure of which is hereby incorporated by reference in its entirety.

### TECHNICAL FIELD

This application relates to the field of data transmission technologies, and in particular, to a data transmission method and apparatus, a computer device, and a storage medium.

### BACKGROUND

With the development of communication technologies, some ultra reliable low latency communication (URLLC) services are widely applied in 5G systems.

Extended reality (XR) services support transmission of services such as augmented reality (AR)/virtual reality (VR)/cloud gaming (CG). These services generally require ultra reliability and low latency, and services supported by URLLC XR may be pseudo-periodic, that is, there is jitter in service arrival time. This may be understood as: that a service does not arrive at a definite point but at any time within a range, and arrival time of different service streams of a same service may differ greatly. In addition, a period of an XR service may be a non-integer period. Moreover, a packet size and a data rate of an XR service are variable.

However, an XR service may cause some resource waste during a transmission process.

### SUMMARY

Based on this, it is required to provide a data transmission method and apparatus, a computer device, and a storage medium.

According to a first aspect, an embodiment of this application provides a data transmission method, and the method includes:
sending, by a first device, indication information to a second device, where the indication information is used to indicate whether to use a target resource for data transmission.

According to a second aspect, an embodiment of this application provides a data transmission apparatus, and the apparatus includes:
an indication information sending module, configured to send indication information, where the indication information is used to indicate whether to use a target resource for data transmission.

According to a third aspect, an embodiment of this application provides a computer device, including a memory and a processor, where the memory stores a computer program, and when the processor executes the computer program, steps of the method provided in the embodiment of the first aspect are implemented.

According to a fourth aspect, an embodiment of this application provides a computer-readable storage medium, where the computer-readable storage medium stores a computer program, and when the computer program is executed by a processor, steps of the method provided in the embodiment of the first aspect are implemented.

According to a fifth aspect, an embodiment of this application provides a computer program product, where the computer program product stores a computer program, and when the computer program is executed by a processor, steps of the method provided in the embodiment of the first aspect are implemented.

This application provides a data transmission method and apparatus, a computer device, and a storage medium. A first device sends indication information to a second device, so that the first device informs the second device of a usage status of a target resource in time, and after receiving the indication information, the second device may determine, based on the indication information, which resources to use, which resources to receive or decode, which resources not to receive or decode, which resources to terminate, and the like.

### BRIEF DESCRIPTION OF DRAWINGS

FIG. 1 is a diagram of an application environment of a data transmission method according to an embodiment.

FIG. 2 is a schematic flowchart of a data transmission method according to an embodiment.

FIG. 3 is a schematic interactive diagram of a data transmission method according to an embodiment.

FIG. 4 is a schematic interactive diagram of a data transmission method according to another embodiment.

FIG. 5 is a schematic interactive diagram of a data transmission method according to another embodiment.

FIG. 6 is a schematic flowchart of a data transmission method according to another embodiment.

FIG. 7 is a schematic interactive diagram of a data transmission method according to another embodiment.

FIG. 8 is a schematic interactive diagram of a data transmission method according to another embodiment.

FIG. 9 is a schematic interactive diagram of a data transmission method according to another embodiment.

FIG. 10 is a schematic flowchart of a data transmission method according to another embodiment.

FIG. 11 is a schematic structural diagram of a data transmission apparatus according to an embodiment.

FIG. 12 is a schematic diagram of an internal structure of a computer device according to an embodiment.

### DESCRIPTION OF EMBODIMENTS

To make objectives, technical solutions, and advantages of this application more clearly, the following further describes this application in detail with reference to the accompanying drawings and embodiments. It should be understood that specific embodiments described in the specification are merely intended to explain this application but not to limit this application.

In related technologies, for AR/VR/CG services in XR services, their possible service models include the following:
VR: uplink (UL) pose information+downlink (DL) video stream;
CG: UL control information (uplink control information)+DL video stream;
AR: UL (pose information+video stream)+DL video stream.
(1) In some scenarios, services supported by URLLC XR are required to support services with a minimum latency of 0.5 ms and a reliability of 99.999%.
(2) These services may be pseudo-periodic, and a service period may be a non-integer period, for example, 16.67 ms.
(3) Arrival time of different service streams of a same service may differ greatly, and different service streams of a same service may also be different in data packet size. For example, there are two service streams: pose information and video information, in one UL period. A period of UL control information or UL pose information may be 4 ms, but a period of a UL video stream may be 16.67 ms. A requirement of the UL control information or the UL pose information for a data packet size may be 100 bytes, and a requirement of the UL video stream for a data packet size is approximately 0.67 Mbps.

Therefore, the XR service has characteristics such as a non-integer service period, pseudo-periodicity, a variable data packet size, and a variable data rate.

Embodiments of this application provide a data transmission method and apparatus, a computer device, and a storage medium, to overcome defects of data transmission, ensure proper transmission of services, and avoid excessive resource waste. It should be noted that the data transmission method provided in embodiments of this application is not limited to achieving the foregoing technical effects, and may further achieve other technical effects. For example, the data transmission method provided in embodiments of this application may further avoid unnecessary power consumption on a UE side or a base station side, thereby improving resource utilization. Embodiments of this application are not limited thereto.

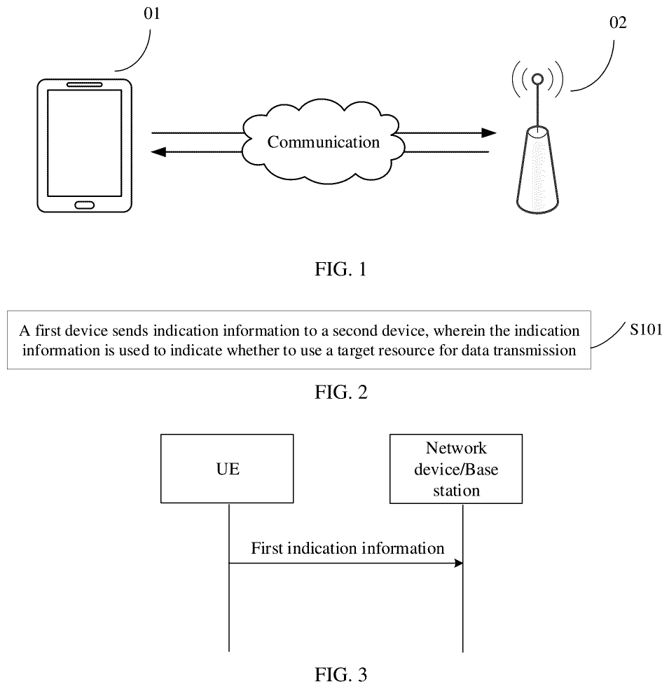

The data transmission method provided in embodiments of this application may be applied to an application scenario shown in FIG. 1. As shown in FIG. 1, the scenario includes a first device 01 and a second device 02, and the first device 01 and the second device 02 may communicate with each other. The first device 01 may be any one of a user equipment (UE), a network device, or a base station. Correspondingly, if the first device 01 is a UE, the second device 02 is a network device or a base station; or if the first device 01 is a network device or a base station, the second device 02 is a UE. The UE may be but is not limited to various devices such as a personal computer, a laptop, a smartphone, a tablet computer, or a portable wearable device, and may alternatively be another network device, which is not limited in embodiments of this application. The network device includes but is not limited to a device with modules such as a policy control function (PCF), a session management function (SMF), and a user plane function (UPF). The base station includes but is not limited to a macro base station, a micro base station, a remote radio unit, a repeater, an indoor distribution system, or the like. It should be noted that in actual application, more UEs may be included, which is not limited to FIG. 1.

FIG. 2 is a flowchart of a data transmission method according to an embodiment. This embodiment relates to a specific implementation of obtaining indication information sent by a first device to a second device. As shown in FIG. 2, the following step is included in this embodiment:

S101: A first device sends indication information to a second device, where the indication information is used to indicate whether to use a target resource for data transmission.

In this embodiment, the first device and the second device are not limited to specific device types, and implementations of the first device and the second device are described above.

For example, if the first device is a UE, the second device is a network device or a base station. In this case, the UE sends indication information to the network device or the base station, where the indication information is used to inform the network device or the base station of whether to use the target resource, that is, to inform the network device or the base station of whether to use the target resource for data transmission or not.

If the first device is a network device or a base station, the second device is a UE. In this case, the network device or the base station sends indication information to the UE, where the indication information is used to inform the UE of whether to use the target resource, that is, to inform the UE of whether to use the target resource for data transmission or not.

In one embodiment, whether to use the target resource for data transmission includes: whether to use the target resource for data sending, and/or whether to use the target resource for data reception.

A data transmission process includes data sending and data receiving. Therefore, indicating whether to use the target resource for data transmission includes: whether to use the target resource for data sending, or whether to use the target resource for data receiving, or whether to use the target resource for both data sending and data receiving.

In one embodiment, whether to use the target resource for data transmission further includes at least one of the following: whether the target resource is to be used for data transmission, whether to terminate the target resource, or whether to use the target resource.

In addition to indicating whether to perform data transmission, indication information may further indicate whether to terminate the target resource or whether there is a need to terminate the target resource, whether there is a need to suspend the target resource or whether to suspend the target resource, whether to use the target resource, or the like. To “terminate” means to drop, and may also mean to stop or the like.

In one embodiment, the indication information is used to indicate at least one of the following: at least one resource in the target resource is to be used for data transmission or is not terminated, all resources in the target resource are to be used for data transmission or are not terminated, at least one resource in the target resource is not to be used for data transmission or is terminated, or all resources in the target resource are not to be used for data transmission or are terminated.

In practical application, the target resource may be more than one resource and may be a plurality of resources. Therefore, the indication information sent by the first device to the second device may indicate one or more or all resources of the target resource. Further, the indication information may indicate that one resource in the target resource is to be used for data transmission or is not dropped, a plurality of resources in the target resource are to be used for data transmission or are not dropped, all resources in the target resource are to be used for data transmission or are not dropped, one resource in the target resource is not to be used for data transmission or is dropped, a plurality of resources in the target resource are not to be used for data transmission or are dropped, or all resources in the target resource are not to be used for data transmission or are dropped.

In one embodiment, the target resource may also refer to at least one of the following: a resource in a first period; a resource in a second period subsequent to the first period; a resource in a configured PUSCH resource pattern; a resource in one or more periods subsequent to the indication information; a resource in one or more PUSCH resource patterns subsequent to the indication information; a resource in a configured PDSCH resource pattern; a resource in one or more PDSCH resource patterns subsequent to the indication information; one or more configured grant CG resources; one or more CG resources in at least one period; one or more semi-persistent scheduling SPS resources; one or more SPS resources in at least one period; or a dynamically scheduled resource.

The target resource may be a resource in the first period, and the first period may generally refer to any period, for example, a current period, a previous period of the current period, a next period following the current period, a period with a specific index, or the like. The target resource may be a resource in a second period subsequent to the first period. For example, if the first period is the current period, the second period is a period subsequent to the current period, or if the first period is a next period following the current period, the second period may be a period subsequent to the next period following the current period. The target resource may alternatively be a resource in a configured PUSCH resource pattern, where the configured PUSCH resource pattern is a physical uplink shared channel (PUSCH) pattern preconfigured by a network device or a base station for a UE. That is, the target resource may be a resource in a preconfigured PUSCH resource pattern. The target resource may alternatively be a resource in one or more periods subsequent to the indication information, that is, the target resource is a resource in any one or more periods after the first device sends the indication information. The target resource may alternatively be a resource in one or more PUSCH resource patterns subsequent to the indication information. The target resource may alternatively be one or more configured grant (CG) resources, one or more CG resources in at least one period, or the like. The target resource may alternatively be an uplink dynamically scheduled resource. For a downlink process, the target resource is a resource in a configured physical downlink shared channel (PDSCH) resource pattern, namely, a resource in a PDSCH pattern preconfigured by a network or base station for a UE. The target resource may alternatively be a resource in one or more PDSCH patterns after the sent indication information, one or more semi-persistent scheduling (SPS) resources, one or more SPS resources in at least one period, or the like. Certainly, the target resource may alternatively be a downlink dynamically scheduled resource or the like.

The target resource described above is merely an example, and the target resource is not limited in embodiments of this application. Regardless of an uplink process from a UE to a network device or a base station, or a downlink process from a network device or a base station to a UE, the target resource indicated in the indication information may be a resource at any position, with any index, or of any type, and the indication information may be sent in any manner, provided that the first device informs, by sending the indication information, the second device of whether the target resource is to be used or not to be used.

Therefore, according to the data transmission method provided in this embodiment of this application, a first device sends indication information to a second device, so that the first device informs the second device of a usage status of a target resource in time, and after receiving the indication information, the second device may determine, based on the indication information, which resources to use, which resources to receive or decode, which resources not to receive or decode, which resources to terminate, and the like. This is equivalent to that the second device may properly schedule transmission resources between the first device and the second device based on the indication information. In this way, transmission resources are properly utilized while normal service data transmission between the first device and the second device is ensured, thereby avoiding resource waste.

In one embodiment, the sending, by a first device, indication information to a second device includes at least one of the following: sending, by the first device, first indication information to the second device, where the first indication information is sent together with a first PUSCH resource; sending, by the first device, second indication information to the second device, where the second indication information is sent before a second PUSCH resource; sending, by the first device, first indication information to the second device, where the first indication information is sent in a first CG period or in a first PUSCH resource pattern; sending, by the first device, second indication information to the second device, where the second indication information is sent in a second CG period or before a second PUSCH resource pattern; sending, by the first device, third indication information to the second device, where the third indication information is sent together with a first PDSCH resource; sending, by the first device, fourth indication information to the second device, where the fourth indication information is sent before a second PDSCH resource; sending, by the first device, third indication information to the second device, where the third indication information is sent in a first SPS period or in a first PDSCH resource pattern; sending, by the first device, fourth indication information to the second device, where the fourth indication information is sent in a second SPS period or before a second PDSCH resource pattern; sending, by the first device, first indication information to the second device, where the first indication information is sent together with a first dynamically scheduled resource; sending, by the first device, second indication information to the second device, where the second indication information is sent before a first dynamically scheduled resource; sending, by the first device, third indication information to the second device, where the third indication information is sent together with a second dynamically scheduled resource; or sending, by the first device, fourth indication information to the second device, where the fourth indication information is sent before a second dynamically scheduled resource.

The first indication information, the second indication information, the third indication information, and the fourth indication information are different in a sending manner. The first indication information, the second indication information, the third indication information, and the fourth indication information may indicate identical content, partially identical content, or completely different content. This is not limited in embodiments of this application.

Specifically, the first indication information refers to indication information in a scenario in which the indication information is sent together with an uplink transmission resource during an uplink process, including: indication information sent together with the first PUSCH resource, indication information sent in the first CG period or the first PUSCH pattern, indication information sent together with the first dynamically scheduled resource, or the like. The second indication information refers to indication information in a scenario in which the indication information is sent in advance during an uplink process, including: indication information sent before the second PUSCH resource, indication information sent in the second CG period or before the second PUSCH pattern, indication information sent before the second dynamically scheduled resource, or the like. The third indication information refers to indication information in a scenario in which the indication information is sent together with a downlink transmission resource during a downlink process, including: indication information sent together with the first PDSCH resource, indication information sent in the first SPS period or the first PDSCH pattern, or indication information sent together with the second dynamically scheduled resource. The fourth indication information refers to indication information in a scenario in which the indication information is sent in advance during a downlink process, including: indication information sent before the second PDSCH resource, indication information sent in the second SPS period or before the second PDSCH pattern, indication information sent before the second dynamically scheduled resource, or the like.

The first PUSCH resource and the second PUSCH resource each refer to any PUSCH resource. The first PUSCH resource and the second PUSCH resource may be a same PUSCH resource or different PUSCH resources. Similarly, the first PDSCH resource and the second PDSCH resource each refer to any PDSCH resource. The first PDSCH resource and the second PDSCH resource may be a same PDSCH resource or different PDSCH resources. Cases of the first CG period or the first PUSCH pattern, the second CG period or the second PUSCH pattern, the first SPS period or the first PDSCH pattern, and the second SPS period or the second PDSCH pattern are similar, and details are not described herein again. The first dynamically scheduled resource is an uplink dynamically scheduled resource, and the second dynamically scheduled resource is a downlink dynamically scheduled resource.

The first indication information, the second indication information, the third indication information, and the fourth indication information are described below from the perspective of an uplink process and a downlink process, respectively.

A data transmission method in an uplink data transmission process is described first. In the uplink process, a UE sends indication information to a network device or a base station, where the indication information is used to inform the network device or the base station of whether to use the target resource for data transmission. The uplink data transmission process is related to the first indication information and second indication information described above. In one embodiment, as shown in FIG. 3, the UE sends the first indication information to the network device or the base station.

In at least one embodiment, the first indication information is carried in at least one of the following: CG uplink control information; a new MAC control element; or a radio resource control message.

The first indication information may be sent together with a PUSCH resource (simultaneous indication). Specifically, the first indication information may be carried in CG-uplink control information (UCI), that is, CG-UCI is used to transmit the first indication information. Alternatively, the first indication information may be carried in a new MAC control element (CE), that is, the MAC CE is used to transmit the first indication information. Alternatively, the first indication information may be carried in a radio resource control (RRC) message. In this embodiment, the first indication information may be carried in a variety of resources or messages or configurations for sending, thereby improving flexibility of sending the first indication information.

For example, the first indication information is carried in CG-UCI. It is assumed that there are four PUSCHs in one period, in CG-UCI of a 1^{st} PUSCH, the first indication information is sent to inform the network device or the base station of a usage status of a subsequent PUSCH following the 1^{st} PUSCH, for example, to inform that all of PUSCHs are not to be transmitted; or to inform that all of the subsequent PUSCHs are not to be transmitted; or to inform a position from which the PUSCH is no longer to be used for data transmission; or to inform which specific PUSCH is no longer to be used for data transmission. In at least one embodiment, the subsequent PUSCH may refer to a subsequent PUSCH in one period or subsequent PUSCHs in a plurality of periods. In at least one embodiment, the specific PUSCH may refer to a PUSCH in a specific period (for example, a current period) or a PUSCH in another period. In this way, after receiving the first indication information, the network device or the base station may schedule PUSCH resources that are no longer to be used to another UE. Further, UCI of each PUSCH may carry first indication information to inform the network device or the base station that subsequent PUSCHs are no longer to be used by the UE, so that the network device or the base station may schedule the PUSCHs that are no longer to be used to another UE.

For another example, it is assumed that four PUSCHs are configured in one CG period. If more bytes is required to be transmitted in a specific CG period, the first indication information is sent to the network device or the base station through CG-UCI of the four PUSCHs, or CG-UCI of one PUSCH among the four PUSCHs, or a MAC CE in each CG of the four PUSCHs, or a MAC CE in a specific CG of the four PUSCHs, or one or more of pieces of CG-UCI of the four PUSCHs, or one or more of MAC CEs in CGs of the four PUSCHs, to inform the network device or the base station of whether a subsequent PUSCH is to be used. For another example, the foregoing assumption is still used, and the first indication information may alternatively be sent to the network device or the base station through CG-UCI of a specific PUSCH among the four PUSCHs, or an MAC CE in a specific CG of the four PUSCHs, to inform the network device or the base station of whether a subsequent PUSCH is to be used. In at least one embodiment, the subsequent PUSCH may refer to a subsequent PUSCH in one period or subsequent PUSCHs in a plurality of periods. In at least one embodiment, the specific PUSCH may refer to a PUSCH in a specific period (for example, a current period) or a PUSCH in another period.

The first indication information is sent to the network device or the base station, so that the network device or the base station allocates resources based on a usage status of UE resources. In this way, data transmission resources may be properly utilized, to improve reasonability of service transmission, thereby avoiding resource waste.

In one embodiment, the data transmission method provided in this embodiment of this application further includes: in a case that a first condition is met, triggering generation of the first indication information, and/or triggering reporting of the first indication information.

Generation or reporting of the first indication information is subject to a trigger condition, and the trigger condition is the first condition. An operation of generation or reporting or both generation and reporting of the first indication information is triggered only when the first condition is met.

It should be understood that triggering generation or reporting or both generation and reporting of the first indication information merely refers to triggering the operation, but whether to execute the operation is uncertain. Therefore, after triggering the operation, further execution also requires a condition setting. Based on this, in one embodiment, in a case that the first condition is met and/or in a case that there is an available uplink transmission resource, the UE sends the first indication information to the network device or the base station.

That is, after generation or reporting of the first indication information is triggered, a process of sending the first indication information to the network device or the base station by the UE is performed in a case that the first condition is met and/or there is an available uplink transmission resource.

The first condition for triggering the operation of generation or reporting of the first indication information and the first condition to which sending the first indication information to the network device or the base station by the UE is subject may be completely identical, or may be partially identical.

In one embodiment, the first condition includes at least one of the following: data with a volume greater than a preset value or bytes with a quantity greater than a preset value or bits with a quantity greater than a preset value is required to be transmitted in one period; data with a volume greater than a preset value or bytes with a quantity greater than a preset value or bits with a quantity greater than a preset value is required to be transmitted in one transmission pattern; data with a volume greater than a first threshold is transmitted in one period; data with a volume less than a second threshold is transmitted in one period; CG uplink control information is configured or activated; DG uplink control information is configured or activated; an uplink control information configuration is disabled; an uplink resource is a preconfigured resource; triggering or reporting of a new MAC control element is supported; a network or a base station activates or enables reporting of the indication information; reporting of the indication information is supported; an uplink resource includes a plurality of PUSCH resources; a plurality of transmission resources are configured in one transmission period; a plurality of PUSCH resources are included in a preconfigured PUSCH resource pattern; a plurality of PUSCHs are required for data transmission in one period; a plurality of PUSCHs are required for data transmission in a preconfigured PUSCH resource pattern; a volume of data to be transmitted is greater than a transport block size of one PUSCH resource or a specified PUSCH resource; a volume of data to be transmitted is less than a transport block size of all PUSCH resources; a volume of data to be transmitted changes; a resource to be transmitted or a transmission resource required to be used changes; a dynamically scheduled resource includes a plurality of PUSCH resources; or the first indication information is generated or triggered or pending; there is available uplink transmission resource; a PUCCH carries the first indication information; a UCI format carries a first field (the first field may carry the first indication information); PUSCH-UCI is activated or available (which may carry the first indication information); CG-UCI is activated or available (which may carry the first indication information); a CG or a PUSCH carries the first indication information; a PDCCH carries the first indication information; or a DCI format carries a first field (the first field may carry the first indication information). In at least one embodiment, the PDCCH or the DCI format may be used to carry dynamic scheduling, or to activate/deactivate a CG, or to activate/deactivate a preconfigured PUSCH, or for other purposes.

The volume of data greater than the preset value or the quantity of bytes greater than the preset value or the quantity of bits greater than the preset value indicates that more data or bytes are required to be transmitted in one period. The volume of data greater than the first threshold is transmitted in one period, and the volume of data less than the second threshold is transmitted in one period, where the first threshold and the second threshold may be different in value.

Conditions that are set for an uplink resource include but are not limited to: there are a plurality of PUSCH resources, a plurality of CG resources are configured in one CG period, a preconfigured PUSCH pattern includes a plurality of PUSCH resources, a plurality of PUSCHs are required to be used in one period, and a volume of data to be transmitted and a transport block size (TBS) of a PUSCH meet a specific relationship, all of which may be one of the first conditions.

That the volume of data to be transmitted and a TBS of a PUSCH meet a specific relationship may be: the volume of data to be transmitted is greater than a TBS of one PUSCH or a specific PUSCH, the volume of data to be transmitted is greater than a TBS of a plurality of PUSCHs, but less than a TBS of all PUSCHs, the volume of data to be transmitted are less than a TBS of all PUSCHs of UL resources, or the like. This is not limited in this embodiment of this application. The specific PUSCH may be a 1^{st} PUSCH, a last PUSCH, a PUSCH with a specific index, or the like.

That the CG uplink control information, namely, CG-UCI, is configured or activated means that UCI information carried on a CG is used to transmit the foregoing indication information. That the DG uplink control information DG-UCI is configured or activated means that UCI information carried on a dynamic grant (DG) is used to transmit the foregoing indication information.

Specific content of the first condition in this embodiment of this application may be set based on actual resources, resources, control information, registration information, and the like. In application, the first condition is met, provided that at least one condition of the above first conditions is met. In this way, by setting each of a plurality of conditions as the first condition, flexibility, timeliness and comprehensiveness of the manner in which the first indication information is sent are improved.

In one embodiment, the UE sends the first indication information to the network device or the base station by: sending, by the UE, the first indication information on the first PUSCH resource to the network device or the base station, where the first indication information is used to indicate whether to use a resource subsequent to the first PUSCH resource. In at least one embodiment, the first PUSCH may be a CG PUSCH or a DG PUSCH.

The first indication information is used to indicate, to the network device or the base station, whether to use a resource subsequent to the first PUSCH resource. The first PUSCH resource refers to any one or more PUSCH resources, and the resource subsequent to the first PUSCH resource may be understood as any resource after the first PUSCH resource. For example, the first PUSCH resource may be a 1^{st} PUSCH in the current period, or a specific PUSCH in a next period, where the specific PUSCH is a 1^{st} PUSCH, or the first X PUSCHs, or the one with the smallest PUSCH index, or with a PUSCH index of Y Herein, X and Y may be predefined or preconfigured by the base station, or configured by the network, which is not limited in embodiments of this application.

In at least one embodiment, the resource subsequent to the first PUSCH resource is at least one of the following: a PUSCH resource in a third period; a PUSCH resource in a configured PUSCH resource pattern; a plurality of dynamically scheduled PUSCH resources; a plurality of dynamically scheduled PUSCH resources subsequent to the first PUSCH resource; PUSCH resources in a plurality of periods; PUSCH resources in a plurality of configured PUSCH resource patterns; PUSCH resources in a plurality of periods subsequent to the first PUSCH resource; PUSCH resources in a plurality of configured PUSCH resource patterns subsequent to the first PUSCH resource; a PUSCH resource that is subsequent to the first PUSCH resource and that is in a third period; or a PUSCH resource that is subsequent to the first PUSCH resource and that is in a configured PUSCH resource pattern. The third period may be the same period as the first period or the second period in the foregoing embodiment, or may be a period different from the first period and the second period.

In at least one embodiment, the resource subsequent to the first PUSCH resource is at least one of the following: all of PUSCH resources subsequent to the first PUSCH resource; at least one or a specific quantity of PUSCH resources subsequent to the first PUSCH resource; one PUSCH resource subsequent to the first PUSCH resource; a plurality of consecutive PUSCH resources subsequent to the first PUSCH resource; or a plurality of inconsecutive PUSCH resources subsequent to the first PUSCH resource.

That is, a quantity of PUSCH resources included in the resource subsequent to the first PUSCH resource is not limited, and may be one or more, and the plurality of PUSCH resources may be consecutive or inconsecutive. The plurality of PUSCH resources also refers to a specific quantity of PUSCH resources.

For example, assuming that the resource subsequent to the first PUSCH resource is a PUSCH resource in the third period and the resource subsequent to the first PUSCH resource is all of PUSCH resources subsequent to the first PUSCH resource, it means that the resource subsequent to the first PUSCH resource is all PUSCH resources that are in the third period and that are subsequent to the first PUSCH resource.

In application, the foregoing limitations on the resource subsequent to the first PUSCH resource may be combined with each other or separated individually to determine a resource to which the resource subsequent to the first PUSCH resource specifically refers.

For example, the UE sends the first indication information to inform the network device or the base station of a usage status of the resource subsequent to the first PUSCH resource, for example, to inform the network device or the base station that all resources subsequent to the first PUSCH resource are not to be used, or to inform a position from which resources subsequent to the first PUSCH resource are no longer to be used for data transmission, or to inform which specific PUSCH is no longer to be used for data transmission. In this way, after receiving the first indication information, the network device or the base station may schedule the first PUSCH resource that is no longer to be used to another UE for use. In at least one embodiment, the resource subsequent to the first PUSCH resource may refer to a resource in one period or in a plurality of periods. In at least one embodiment, the resource subsequent to the first PUSCH resource may refer to a resource in a specific period (for example, a current period) or in another period.

For another example, the first PUSCH resource is a current PUSCH in a current period, and the first indication information indicates whether another PUSCH subsequent to the current PUSCH in the current period is to be transmitted. For example, if it indicates that the another PUSCH is to be dropped (terminated or stopped), it means that transmission of the subsequent PUSCH is to be dropped. The another PUSCH may be one PUSCH or a plurality of PUSCHs.

In one embodiment, the first indication information is used to indicate at least one of the following: whether all of resources subsequent to the first PUSCH resource are to be used for data transmission; whether each of resources subsequent to the first PUSCH resource is to be used for data transmission; whether a plurality of resources subsequent to the first PUSCH resource are to be used for data transmission; whether one of resources subsequent to the first PUSCH resource is to be used for data transmission; a specific PUSCH resource in resources subsequent to the first PUSCH resource; a 1^{st} resource subsequent to the first PUSCH resource; a resource, for specific data, closest to the first PUSCH resource and subsequent to the first PUSCH resource; whether each of the target resource is to be used for data transmission; whether one resource or one specific resource in the target resource is to be used for data transmission; whether a plurality of resources or a plurality of specific resources in the target resource are to be used for data transmission; or whether each of the target resource is to be used for data transmission.

The first indication information sent by the UE to the network device or the base station may specifically indicate all resources, each resource, a plurality of resources, one resource, a specific resource, or the like among resources subsequent to the first PUSCH resource, or may be all, any one or a specific one, any multiple or specific multiple, each one, or the like of resources of the target resource. This is not limited in embodiments of this application.

In one embodiment, the first indication information is further used to indicate at least one of the following: whether a next PUSCH following the first PUSCH is to be used for data transmission; whether all PUSCHs in a CG period subsequent to the first PUSCH are to be used for data transmission; whether all PUSCHs in a PUSCH resource pattern subsequent to the first PUSCH are to be used for data transmission; or whether a PUSCH at a specified position subsequent to the first PUSCH is to be used for data transmission.

The next PUSCH following the first PUSCH may be a next one following the first PUSCH in terms of position, or a next one in terms of transmission order. The CG period and the PUSCH pattern are preconfigured by the network device or the base station for the UE, so that the first indication information sent by the UE to the network device or the base station may indicate all resources in a CG period or a PUSCH pattern subsequent to the first PUSCH. Alternatively, the first indication information indicates a designated position subsequent to the first PUSCH, for example, a resource that is subsequent to the first PUSCH and that has a preset offset relative to the first PUSCH.

The designated position may be one position or a plurality of positions.

In at least one embodiment, the first PUSCH resource in the foregoing embodiment may include one first PUSCH resource or a plurality of first PUSCH resources.

In a case of one first PUSCH resource, the first indication information is carried on the one first PUSCH resource. In a case of a plurality of first PUSCH resources, the first indication information is carried on the plurality of first PUSCH resources, or on at least a part of the plurality of first PUSCH resources.

For example, the first indication information may be carried on one PUSCH resource, or a plurality of PUSCH resources may carry respective first indication information.

Based on this, in one embodiment, the UE sends the first indication information to the network device or the base station by at least one of the following: sending, by the UE, the first indication information on one first PUSCH to the network device or the base station; sending, by the UE, the first indication information on a plurality first PUSCHs to the network device or the base station; sending, by the UE, the first indication information on each PUSCH to the network device or the base station; or sending, by the UE, the first indication information on a specific first PUSCH to the network device or the base station.

In this embodiment, if the first indication information is carried on one first PUSCH resource, the UE sends the first indication information on the one first PUSCH. If the first indication information is carried on a plurality of first PUSCH resources, the UE may send the first indication information on the plurality of first PUSCHs, or on each PUSCH, or on a specific first PUSCH, or on each transmitted PUSCH, or on a plurality of transmitted first PUSCHs. In this way, the first indication information is sent in different carrying manners in different cases, so that after receiving the first indication information, the network device or the base station may properly allocate transmission resources in a more targeted and flexible manner, thereby avoiding resource waste.

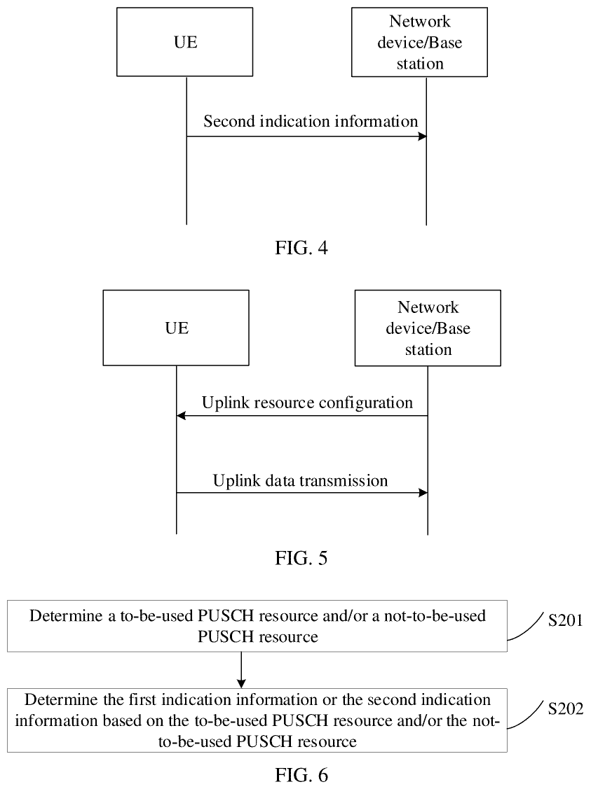

For an uplink process, as shown in FIG. 4, in another embodiment, the UE sends the indication information to the network device or the base station by: sending second indication information to the network device or the base station by the UE, where the second indication information is carried in a target transmission resource or target transmission information. In at least one embodiment, the target transmission resource or the target transmission information may be a physical uplink control channel (PUCCH) resource, UCI, a scheduling request (SR), a PUSCH, a MAC CE, or radio resource control RRC. The UCI may be new UCI, where “new” means: a new type, name, index, configuration period, configuration resource, or the like.

In one embodiment, the UE sends the second indication information to the network device or the base station, where the second indication information is carried on a target transmission resource or target transmission information before the second PUSCH resource. Alternatively, the UE sends the second indication information to the network device or the base station, where the second indication information is sent on a target transmission resource or target transmission information before the second PUSCH resource.

In this embodiment, the second indication information is still carried in the target transmission resource or the target transmission information, or is sent by using the target transmission resource or the target transmission information. However, the target transmission resource or the target transmission information is a resource or information before the second PUSCH resource.

In at least one embodiment, the target transmission resource in the foregoing embodiment may include one target transmission resource or a plurality of target transmission resources. In a case of one target transmission resource, the second indication information is carried on the one target transmission resource. In a case of a plurality of target transmission resources, the second indication information is carried on the plurality of target transmission resources, or on at least a part of the plurality of target transmission resources. For example, the second indication information may be carried on one target transmission resource, or a plurality of target transmission resources may carry respective second indication information. If the second indication information is carried on one target transmission resource, the base station sends the first indication information on the one target transmission resource. If the first indication information is carried on a plurality of target transmission resources, the UE may send the second indication information on the plurality of target transmission resources, or on each target transmission resource, or on a specific first target transmission resource, or on each transmitted target transmission resource, or on a plurality of transmitted first target transmission resources. In this way, the second indication information is sent in different carrying manners in different cases, so that after receiving the second indication information, the network device or the base station may properly allocate transmission resources in a more targeted and flexible manner, thereby avoiding resource waste.

After the UE sends the second indication information to the network device or the base station, the network device or the base station is informed of a usage status of a subsequent PUSCH, for example, to inform that all PUSCHs are not to be transmitted; or to inform that all subsequent PUSCHs are not to be transmitted; or to inform a position from which the PUSCH is no longer to be used for data transmission; or to inform a specific PUSCH which is no longer to be used for data transmission. In at least one embodiment, the subsequent PUSCH may refer to a PUSCH in one period or in a plurality of periods. In at least one embodiment, the specific PUSCH may refer to a PUSCH in a specific period (for example, a current period) or in another period.

For example, a CG configuration is used as an example, and it is assumed that four PUSCHs are configured in one CG period. If more bytes are required to be transmitted in a specific CG period, the second indication information may be sent to the network device or the base station by using CG-UCI of the four PUSCHs, or CG-UCI of a specific PUSCH among the four PUSCHs, or one or more of pieces of CG-UCI of the four PUSCHs, or one or more of MAC CEs in CGs of the four PUSCHs, or a MAC CE in a specific CG of the four PUSCHs, to inform the network device or the base station of a usage status of a subsequent PUSCH, for example, whether to use a subsequent PUSCH, whether to use a PUSCH subsequent to the current PUSCH (in the current period), or whether to use subsequent PUSCHs for continuous transmission.

The second PUSCH resource may refer to any PUSCH resource. In at least one embodiment, the second PUSCH resource is at least one of the following: a PUSCH resource before a CG period; a PUSCH resource before a PUSCH resource pattern; a PUSCH resource before a specific CG period; a PUSCH resource before a specific PUSCH resource pattern; a PUSCH resource at a 1^{st} position; a PUSCH resource at a specific position; or a plurality of dynamically scheduled PUSCH resources. In at least one embodiment, the second PUSCH may be a CG PUSCH or a DG PUSCH.

The CG period and the PUSCH pattern are preconfigured by the network device or the base station for the UE. On the UE side, the second PUSCH resource may be a PUSCH resource before a current CG period or a current PUSCH pattern, or a PUSCH resource before a specific CG period or a specific PUSCH pattern. The specific CG period or the specific PUSCH pattern may be a previous one, a next one, or the like, which is not limited in embodiments of this application. The second PUSCH resource may alternatively be a PUSCH resource at a 1^{st} position or a specific position, or the like.

The target transmission resource or the target transmission information is before the second PUSCH resource, and there is a specific positional relationship between the target transmission resource (or the target transmission information) and the second PUSCH resource. In one embodiment, there is a fixed offset between the target transmission resource and the second PUSCH resource; or there is a fixed offset between the target transmission resource and an uplink resource configuration, where the uplink resource configuration is an uplink resource configuration corresponding to the second PUSCH resource.

The fixed offset may be a preconfigured offset. The target transmission resource is a resource that is ahead of the second PUSCH resource by the fixed offset. The uplink resource configuration refers to a configuration corresponding to the second PUSCH resource, and therefore the target transmission resource may alternatively be a resource that is ahead of the uplink resource configuration by the fixed offset. In at least one embodiment, the fixed offset may be configured, or indicated, or predefined.

In one embodiment, the second indication information is used to indicate whether a resource in a CG period or PUSCH resource pattern is to be used for data transmission; or the second indication information is used to indicate whether a plurality of dynamically scheduled PUSCH resources are to be used for data transmission.

The resource in the CG period or the PUSCH pattern and the plurality of dynamically scheduled PUSCH resources each may be considered as a resource indicated by the second indication information. The resource indicated by the second indication information is described from different perspectives.

In one embodiment, the resource indicated by the second indication information is at least one of the following: a resource in a CG period or PUSCH resource pattern closest to the target transmission resource or the target transmission information; a resource in one CG period or PUSCH resource pattern subsequent to the target transmission resource or the target transmission information; a resource in a plurality of CG periods or PUSCH resource patterns subsequent to the target transmission resource or the target transmission information; a resource in a CG period or PUSCH resource pattern corresponding to the second PUSCH resource; a resource in a plurality of dynamically scheduled PUSCH resources subsequent to the target transmission resource or the target transmission information; or a resource in a plurality of dynamically scheduled PUSCH resources corresponding to the second PUSCH resource.

In this embodiment, a position of the resource indicated by the second indication information is required to be identified. For example, the resource indicated by the second indication information may be in a CG period or PUSCH pattern closest to the target transmission resource or the target transmission information, or may be in one CG period or PUSCH pattern or a plurality of CG periods or PUSCH patterns subsequent to the target transmission resource or the target transmission information, or in a CG period or PUSCH pattern corresponding to the second PUSCH resource, or the like.

In another embodiment, the resource indicated by the second indication information includes at least one of the following: one PUSCH resource in a CG period or PUSCH resource pattern; a plurality of PUSCH resources in a CG period or PUSCH resource pattern; a specific PUSCH resource in a CG period or PUSCH resource pattern; a plurality of consecutive PUSCH resources in a CG period or PUSCH resource pattern; a plurality of inconsecutive PUSCH resources in a CG period or PUSCH resource pattern; all PUSCH resources in a CG period or PUSCH resource pattern; one or more PUSCH resources in a plurality of dynamically scheduled PUSCH resources; a specific PUSCH resource in a plurality of dynamically scheduled PUSCH resources; whether each of the target resource is to be used for data transmission; whether one resource or one specific resource in the target resource is to be used for data transmission; whether a plurality of resources or a plurality of specific resources in the target resource are to be used for data transmission; or whether each of the target resource is to be used for data transmission.

In this embodiment, a specific resource, at a corresponding position, indicated by the second indication information is required to be identified, for example, one PUSCH resource, a plurality of PUSCH resources, a specific PUSCH resource, a plurality of consecutive PUSCH resources, a plurality of inconsecutive PUSCH resources, or the like in a CG period or PUSCH resource pattern.

The resource indicated by the second indication information may alternatively be about the target resource, for example, all resources of the target resource, a part of resources or a specific resource of the target resource, one resource or each resource in the target resource, or the like.

In at least one embodiment, the resource indicated by the second indication information may refer to a resource in one period or a plurality of periods. In at least one embodiment, the resource indicated by the second indication information may refer to a resource in a specific period (for example, a current period) or another period.

In the foregoing embodiment, the resource indicated by the second indication information may include resources indicated in different aspects. In this way, after the second indication information is sent to the network device or the base station, the network device or the base station may more accurately determine a usage status of a resource indicated by the UE and therefore allocate the resource indicated by the UE more properly, thereby ensuring appropriateness of service transmission.

Based on the resource indicated by the second indication information, in one embodiment, the second indication information is used to indicate any one of the following: whether all of resources in the CG period or the PUSCH resource pattern are to be used for data transmission; whether each of resources in the CG period or the PUSCH resource pattern is to be used for data transmission; whether a plurality of resources in the CG period or the PUSCH resource pattern are to be used for data transmission; whether one of resources in the CG period or the PUSCH resource pattern is to be used for data transmission; whether a specific one of resources in the CG period or the PUSCH resource pattern is to be used for data transmission; whether a plurality of resources in the plurality of dynamically scheduled PUSCH resources are to be used for data transmission; whether a specific resource in the plurality of dynamically scheduled PUSCH resources is to be used for data transmission; whether one resource in the plurality of dynamically scheduled PUSCH resources is to be used for data transmission; whether each resource in the plurality of dynamically scheduled PUSCH resources is to be used for data transmission; whether all of the plurality of dynamically scheduled PUSCH resources are to be used for data transmission; whether a next uplink resource is to be used for data transmission; or whether a resource in a fourth period or resource pattern is to be used for transmission.

The resource indicated by the second indication information in this embodiment correspond to that in the foregoing embodiment. Herein, specific resources indicated by the second indication information are limited. For example, the second indication information may indicate all resources, each resource, a plurality of resources, or the like in the CG period or the PUSCH pattern, and may indicate each resource, all resources, a specific resource, or the like in the plurality of dynamically scheduled PUSCH resources. Further, the second indication information may alternatively indicate a next uplink resource, a resource in a fourth period or PUSCH pattern, or the like. In this way, the second indication information may indicate a resource at any position, in any period, or of any type of configuration, so that the network device or the base station may more comprehensively know a resource usage status of the UE, which greatly improves appropriateness of subsequent resource allocation.

Sending the second indication information to the network device or the base station by the UE is similar to sending the first indication information to the network device or the base station by the UE in the foregoing embodiment. Generation or reporting of the second indication information is required to be triggered, and a condition to which sending of the second indication information is subject is required to be set. In one embodiment, the UE sends the second indication information to the network device or the base station by: in a case that a second condition is met, performing at least one of the following: triggering the second indication information by the UE, reporting the second indication information by the UE, or sending the second indication information to the network device or the base station by the UE. In at least one embodiment, the second condition includes at least one of the following: data with a volume greater than a preset value or bytes with a quantity greater than a preset value or bits with a quantity greater than a preset value is required to be transmitted in one period; data with a volume greater than a preset value or bytes with a quantity greater than a preset value or bits with a quantity greater than a preset value is required to be transmitted in one transmission pattern; data with a volume greater than a third threshold is transmitted in one period; data with a volume less than a fourth threshold is transmitted in one period; a resource configuration for transmitting the second indication information is allowed or disabled; the network or the base station activates or enables reporting of the indication information; reporting of the indication information is supported; triggering or reporting of a new MAC control element is supported; the uplink resource is a preconfigured resource; the uplink resource includes a plurality of PUSCH resources; a plurality of transmission resources are configured in one transmission period; a plurality of PUSCH resources are included in a preconfigured PUSCH resource pattern; a plurality of PUSCHs are required for data transmission in one period; a plurality of PUSCHs are required for data transmission in a preconfigured PUSCH resource pattern; a dynamically scheduled resource includes a plurality of PUSCH resources; the second indication information is generated or triggered or pending; a volume of data to be transmitted is greater than a transport block size of one PUSCH resource or a specified PUSCH resource; a volume of data to be transmitted is less than a transport block size of all PUSCH resources; a volume of data to be transmitted is greater than a TBS of a plurality of PUSCHs and less than a TBS of all PUSCHs; a volume of data to be transmitted changes; a resource to be transmitted or a transmission resource to be used changes; there is an available uplink transmission resource; there is an available new transmission resource; a PUCCH carries the second indication information; a UCI format carries a first field (the first field carries the second indication information); PUSCH-UCI is activated or available (which may carry the second indication information); CG-UCI is activated or available (which may carry the second indication information); a CG or PUSCH carries the second indication information; a PDCCH carries the second indication information; or a DCI format carries a first field (the first field may carry the second indication information). In at least one embodiment, the PDCCH or the DCI format may be used to carry dynamic scheduling, or to activate/deactivate a CG, or to activate/deactivate a preconfigured PUSCH, or for other purposes.

In this embodiment, for a condition for triggering generation or reporting of the second indication information and a condition for sending the second indication information, reference may be made to the description of the embodiment of sending the first indication information. Details are not described herein again. The second condition is the same as the first condition described above, and for details, reference may be made to the description of the first condition.

The uplink resource configuration related in the foregoing embodiment is described below by using specific embodiments.

In one embodiment, as shown in FIG. 5, the method further includes: receiving, by the UE, an uplink resource configuration sent by a network device or a base station.

The uplink resource configuration includes a preconfigured resource or a dynamically scheduled resource. In at least one embodiment, the dynamically scheduled resource includes a plurality of PUSCH resources. In at least one embodiment, the preconfigured resource includes a CG or a preconfigured PUSCH resource pattern. In addition, for the uplink resource configuration, in one embodiment, the uplink resource configuration indicates that a plurality of PUSCH resources are included in one CG period and/or that a plurality of PUSCH resources are included in one PUSCH resource pattern.

After receiving the uplink resource configuration sent by the network device or the base station, the UE sends the first indication information or the second indication information to the network device or the base station based on the uplink resource configuration.

In one embodiment, the uplink resource configuration includes at least one of the following: a CG index; a CG period; a quantity of PUSCH resources in a CG period; resource information of at least one PUSCH resource in one CG period; uplink control information in one CG period; uplink control information of a CG PUSCH resource; a PUSCH resource pattern index; PUSCH resource pattern periodicity or aperiodicity; a quantity of PUSCH resources in a PUSCH resource pattern; resource information of at least one PUSCH resource in one PUSCH resource pattern; uplink control information in one PUSCH resource pattern; uplink control information of a PUSCH resource in a PUSCH resource pattern; uplink control information of a plurality of dynamically scheduled PUSCH resources; information of at least one of a plurality of dynamically scheduled PUSCH resources; or a quantity of PUSCH resources in a plurality of dynamically scheduled PUSCH resources.

A CG configuration is used as an example. The UE receives a preconfigured CG configuration from the base station. The CG configuration includes a CG index, a CG period, and a quantity of resources in a CG period, for example, a quantity of PUSCH or CG PUSCH resources.

A PUSCH pattern is used as an example. The UE receives a preconfigured PUSCH pattern from the base station. The PUSCH pattern includes a PUSCH pattern index; PUSCH pattern periodicity or aperiodicity; a quantity of PUSCH resources in the PUSCH pattern; and the like. For example, one preconfigured PUSCH pattern includes a plurality of PUSCH resources, and intervals between the plurality of PUSCH resources may be equal intervals or non-equal intervals. The preconfigured PUSCH pattern may be periodic or aperiodic.

Dynamic scheduling is used as an example, and the uplink resource configuration may further include: information of at least one PUSCH resource in a plurality of dynamically scheduled PUSCH resources; and a quantity of PUSCH resources in a plurality of dynamically scheduled PUSCH resources.

The uplink resource configuration further includes resource information of at least one PUSCH resource in a CG period or resource information of at least one PUSCH resource in a PUSCH resource pattern. The resource information includes position information, time domain and frequency domain resource information, a resource offset, redundancy version (RV) information, an RV offset, hybrid automatic repeat request (HARQ) process information, a HARQ process information offset, number information, a specific resource, and the like.

In at least one embodiment, the position information includes a start position of at least one PUSCH resource, an end position of at least one PUSCH resource, a position of a 1^{st} PUSCH resource in at least one PUSCH resource, a position of a specific PUSCH resource in at least one PUSCH resource, and the like. The time domain and frequency domain resource information includes time domain and frequency domain resource information of at least one PUSCH resource. The resource offset includes a resource offset of each PUSCH resource in at least one PUSCH resource relative to a 1^{st} PUSCH resource, a resource offset of each PUSCH resource in at least one PUSCH resource relative to a specific PUSCH resource, or a resource offset of each PUSCH resource in at least one PUSCH resource relative to a last PUSCH resource. The RV information includes redundant version RV information of at least one PUSCH resource, and the RV offset includes an RV offset of each PUSCH resource in at least one PUSCH resource relative to a specific PUSCH resource; or an RV offset of each PUSCH resource in at least one PUSCH resource relative to a last PUSCH resource. The HARQ process information includes HARQ process information of at least one PUSCH resource, and the HARQ process information offset includes a HARQ process information offset of each PUSCH resource in at least one PUSCH resource relative to a 1^{st} PUSCH resource; a HARQ process information offset of each PUSCH resource in at least one PUSCH resource relative to a specific PUSCH resource; or a HARQ process information offset of each PUSCH resource in at least one PUSCH resource relative to a last PUSCH resource. The number formation includes a number of a 1^{st} PUSCH resource in at least one PUSCH resource and a number of a specific PUSCH resource in at least one PUSCH resource. The specific resource includes a 1^{st} resource or a last resource or a specific resource in at least one PUSCH resource.

The CG configuration further includes uplink control information of a CG period, a CG PUSCH resource, a PUSCH resource pattern, a PUSCH resource in a PUSCH resource pattern, a plurality of dynamically scheduled PUSCH resources, and the like. In at least one embodiment, the uplink control information is used to indicate at least one of the following: whether the indication information is included; content of the indication information; a resource carrying the indication information; a PUSCH resource indicated by the indication information; a specified PUSCH resource; a position of the indication information; a size of bytes occupied by the indication information; a disable flag or an enable flag; or a resource status or a resource usage condition.

Specifically, whether indication information is included refers to whether the uplink control information includes the indication information.

The content of the indication information is content in the first indication information or content in the second indication information.

The resource carrying the indication information: for example, a PUSCH resource, a MAC CE, new UCI, or the like.

The PUSCH resource indicated by the indication information: for example, a resource that is subsequent to the first PUSCH resource and that is indicated in the first indication information, or the like.

The specified PUSCH resource: A CG configuration is used as an example, for a CG period, CG-UCI (uplink control information) configuration information may indicate a specific CG PUSCH or each CG PUSCH. The specific CG PUSCH may be a 1^{st} resource, or a last resource, or a resource with a smallest CG PUSCH index, or the like in a period.

The position of the indication information and the size of the bytes occupied by the indication information: A CG configuration is still used as an example. The CG-UCI configuration information may indicate a position of the first indication information and/or a size of bits occupied by the first indication information, and a position of the second indication information and/or a size of bits occupied by the second indication information.

The disable flag or enable flag: The CG-UCI configuration information may further include an “enable” or “disable” flag.

For the resource status or the resource usage condition, in one embodiment, the resource status or the resource usage condition includes: that a plurality of PUSCH resources are configured in one CG period; that a plurality of PUSCH resources are configured in one PUSCH resource pattern; that a plurality of PUSCH resources are used for data transmission; that a volume of data to be transmitted is greater than a transport block size of one PUSCH or a specified PUSCH; or that a volume of data to be transmitted is less than a transport block size of all PUSCHs of an uplink resource.

Specifically, the resource status or the resource usage condition is: a plurality of CG resources are configured in one CG period, and/or a plurality of PUSCHs are required to be used, and/or a volume of data to be transmitted is greater than a TBS of one PUSCH or a specific PUSCH, and/or a volume of data to be transmitted is less than a TBS of all PUSCHs of the UL resource, and the like. It should be noted that the usage condition herein is merely an example. In practical application, the resource usage condition may be the same as the first condition or the second condition in the foregoing embodiment. That is, a condition in the first condition or the second condition in the foregoing embodiment is also applicable to the resource status or the resource usage condition herein. Details are not described again in this embodiment of this application.

In one embodiment, still referring to FIG. 5, after the UE receives the uplink resource configuration, the method further includes: performing, by the UE, uplink data transmission based on the uplink resource configuration.

In at least one embodiment, the UE performs uplink data transmission based on the uplink resource configuration by: performing, by the UE, data transmission on all PUSCH resources based on the uplink resource configuration; or performing, by the UE, data transmission on a part of PUSCH resources based on the uplink resource configuration; or terminating, by the UE, a part of PUSCH resources based on the uplink resource configuration.

After receiving the uplink resource configuration, the UE may use all PUSCH resources or a part of PUSCH resources. The UE may terminate (that is, drop) another part of PUSCH resources that is not to be used.

Resources represented by all PUSCH resources on which the UE performs data transmission based on the uplink resource configuration vary in different cases. For example, resources to which the all PUSCH resources refer may be determined based on a CG period, or based on a PUSCH pattern, or based on a plurality of dynamically scheduled PUSCH resources.

Based on this, an embodiment is provided to describe the above cases. In one embodiment, the UE performs data transmission on all PUSCH resources based on the uplink resource configuration by:
performing, by the UE, the data transmission on all PUSCH resources in one CG period based on the uplink resource configuration; or
performing, by the UE, the data transmission on a PUSCH resource, corresponding to a specific position or index, in one CG period based on the uplink resource configuration; or
performing, by the UE, the data transmission on all PUSCH resources in one PUSCH resource pattern based on the uplink resource configuration; or
performing, by the UE, the data transmission on a PUSCH resource, corresponding to a specific position or index, in one PUSCH resource pattern based on the uplink resource configuration; or
performing, by the UE, the data transmission on all PUSCH resources in a plurality of dynamically scheduled PUSCH resources based on the uplink resource configuration; or
performing, by the UE, the data transmission on all PUSCH resources, corresponding to a specific position or index, in a plurality of dynamically scheduled PUSCH resources based on the uplink resource configuration; or
performing, by the UE, the data transmission on all PUSCH resources in a plurality of CG periods based on the uplink resource configuration; or
performing, by the UE, the data transmission on a PUSCH resource, corresponding to a specific position or index, in a plurality of CG periods based on the uplink resource configuration; or
performing, by the UE, the data transmission on all PUSCH resources in a plurality of PUSCH resource patterns based on the uplink resource configuration; or
performing, by the UE, the data transmission on a PUSCH resource, corresponding to a specific position or index, in a plurality of PUSCH resource patterns based on the uplink resource configuration.

The specific position or index may be one position or a plurality of positions.

In this embodiment, all PUSCH resources refer to all resources in one or more CG periods, or all resources, corresponding to a specific position or index, in one or more CG periods, or all resources in one or more PUSCH patterns, or all resources, corresponding to a specific position or index, in one or more PUSCH patterns, or all resources corresponding to a plurality of dynamically scheduled PUSCH resources, or all resources, corresponding to a specific position or index, in a plurality of dynamically scheduled PUSCH resources.

Similarly, a resource represented by a part of PUSCH resources on which the UE performs data transmission based on the uplink resource configuration varies in different cases. Similar to the case of the all resources described above, in one embodiment, the UE performs data transmission on a part of PUSCH resources based on the uplink resource configuration by:
performing, by the UE, the data transmission on a part of PUSCH resources in one CG period based on the uplink resource configuration; or
performing, by the UE, the data transmission on a part of PUSCH resources, corresponding to a specific position or index, in one CG period based on the uplink resource configuration; or
performing, by the UE, the data transmission on a part of PUSCH resources in one PUSCH resource pattern based on the uplink resource configuration; or
performing, by the UE, the data transmission on a part of PUSCH resources, corresponding to a specific position or index, in one PUSCH resource pattern based on the uplink resource configuration; or
performing, by the UE, the data transmission on a part of PUSCH resources in a plurality of dynamically scheduled PUSCH resources based on the uplink resource configuration; or
performing, by the UE, the data transmission on a part of PUSCH resources, corresponding to a specific position or index, in a plurality of dynamically scheduled PUSCH resources based on the uplink resource configuration; or
performing, by the UE, the data transmission on a part of PUSCH resources in a plurality of CG periods based on the uplink resource configuration; or
performing, by the UE, the data transmission on a part of PUSCH resources, corresponding to a specific position or index, in a plurality of CG periods based on the uplink resource configuration; or
performing, by the UE, the data transmission on a part of PUSCH resources in a plurality of PUSCH resource patterns based on the uplink resource configuration; or
performing, by the UE, the data transmission on a part of PUSCH resources, corresponding to a specific position or index, in a plurality of PUSCH resource patterns based on the uplink resource configuration.

In this embodiment, the case of a part of PUSCH resources is the same as the case of all PUSCH resources described above, and details are not described herein again.

The UE sends the indication information to the network device or the base station for a purpose of informing the network device or the base station of whether to use a subsequent resource. Therefore, the UE is required to determine a to-be-used resource and a not-to-be-used resource first, and generate, based on the to-be-used resource and the not-to-be-used resource, the first indication information and the second indication information.

In this case, in one embodiment, as shown in FIG. 6, the method further includes:

S201: It is determined a to-be-used PUSCH resource and/or a not-to-be-used PUSCH resource.

S202: It is determined the first indication information or the second indication information based on the to-be-used PUSCH resource and/or the not-to-be-used PUSCH resource.

A CG is used as an example. The UE determines a to-be-used CG PUSCH resource or a not-to-be-used CG PUSCH resource, generates first indication information or second indication information based on the determined to-be-used CG PUSCH resource or not-to-be-used CG PUSCH resource, and reports the first indication information or the second indication information to the network device or the base station, so that the network device or the base station knows a resource usage status of the UE in time.

The first indication information and the second indication information are sent to the network device or the base station. The indication information is used for indicating the network device or the base station to perform at least one of the following: determining whether to receive a PUSCH transmission; determining a PUSCH required to be received or decoded; determining a PUSCH not required to be received or decoded; or determining a PUSCH required to be terminated.

Specifically, the network device or the base station determines, based on the first indication information and the second indication information, which PUSCH resource are to be used or which PUSCH resources are not to be used. For a resource that is determined to be used, the base station may receive or decode the resource. For a resource that is determined not to be used, the base station may not receive or decode the resource, or the base station may reallocate a position of the resource to another UE or schedule a position of the resource to another UE. In this way, the resource of the UE may be scheduled or allocated to another UE, thereby avoiding resource waste.

In one embodiment, the method further includes: performing data transmission on the to-be-used PUSCH resource, and/or skipping performing data transmission on the not-to-be-used PUSCH resource, and/or terminating the not-to-be-used PUSCH resource.

For the UE, after determining the to-be-used PUSCH resource and/or the not-to-be-used PUSCH resource, the UE may further terminate the not-to-be-used PUSCH resource in addition to performing data transmission on the to-be-used PUSCH resource and skipping performing data transmission on the not-to-be-used PUSCH resource.

In one embodiment, the method further includes: if there is a conflict or multiplexing of PUSCH resources, determining the not-to-be-used PUSCH resource as a low-priority resource.

In some scenarios, if the UE finds that there is a conflict or multiplexing of PUSCH resources, the UE may consider the not-to-be-used resource as a low-priority resource. In this way, the not-to-be-used resource is determined to have a low priority, to avoid the low-priority resource, so as to alleviate the conflict or multiplexing of the PUSCH resources.

In all foregoing embodiments, operations such as reporting the first indication information or the second indication information, determining the to-be-used PUSCH resource or the not-to-be-used PUSCH resource, and performing uplink data transmission may be performed based on an indication of the network device or the base station. Based on this, in one embodiment, the method further includes: determining, based on an indication of the network device or the base station, whether to perform at least one of the following: reporting the first indication information; reporting the second indication information; triggering or generating the first indication information; triggering or generating the second indication information; triggering reporting of the first indication information; triggering reporting of the second indication information; determining whether to terminate a resource; triggering or determining the to-be-used PUSCH resource; triggering or determining transmission of the not-to-be-used PUSCH resource; or triggering the uplink data transmission.

In this embodiment, all operations related to the UE, such as reporting, triggering, or generating the first indication information and the second indication information, and terminating or skipping using a resource or uplink data transmission are set to be performed based on the indication of the network device or the base station, which improves interactivity between the UE and the network device or the base station.

In this embodiment of this application, for whether to transmit a PUSCH, in another implementation, the base station indicates, through a PDCCH or DCI, whether to transmit a target PUSCH.

In at least one embodiment, the base station may use a PDCCH to carry the first indication information or the second indication information; or a DCI format carries a first field (the first field may carry the first indication information or the second indication information). In at least one embodiment, the PDCCH or the DCI format may be used to carry dynamic scheduling, or to activate/deactivate a CG, or to activate/deactivate a preconfigured PUSCH, or for other purposes.

Accordingly, the UE, based on the indication of the base station, determines a to-be-transmitted PUSCH or a not-to-be-transmitted PUSCH and/or performs transmission or dropping.

The data transmission method in the uplink data transmission process is described above. The following describes the data transmission method in a downlink data transmission process. The downlink process means that the network device or the base station sends indication information to the UE, where the indication information is used to inform the UE of whether to use the target resource for data transmission. That is, after receiving the indication information, the UE determines which resources to use or which resources not to use.

The downlink data transmission process is related to the third indication information and the fourth indication information described above. That is, the downlink third indication information corresponds to the uplink first indication information, and the downlink fourth indication information corresponds to the uplink second indication information. It should be noted that limitations in various embodiments related to the downlink data transmission process are the same as those in the uplink data transmission process. Details are not described again in the following embodiments, and reference may be made to the foregoing embodiments. A difference lies in that, the indication information during the downlink data transmission process is limited to being carried in downlink related resources, such as a physical downlink control channel (PDCCH), a downlink dynamically scheduled PDSCH, SPS, and the like.

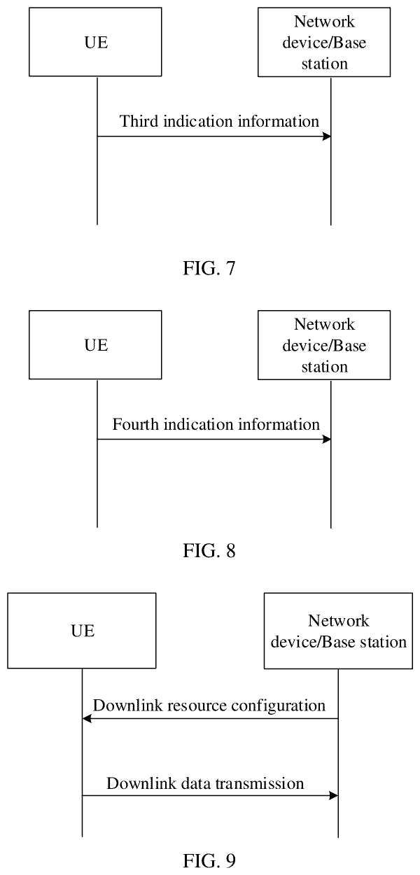

In one embodiment, as shown in FIG. 7, sending the third indication information to the second device by the first device means that sending the third indication information to the UE by the network device or the base station. In at least one embodiment, the third indication information is carried in at least one of the following: a PDCCH; SPS; a downlink dynamically scheduled PDSCH; SPS downlink control information; a new MAC control element; or a radio resource control message.

In one embodiment, the method further includes: in a case that a third condition is met, triggering generation of the third indication information, and/or triggering delivery of the third indication information. In one embodiment, the network device or the base station sends the third indication information to the UE by: in a case that the third condition is met and/or in a case that there is an available downlink transmission resource, sending, by the network device or the base station, the third indication information to the UE. In at least one embodiment, the third condition includes at least one of the following: data with a volume greater than a preset value or bytes with a quantity greater than a preset value or bits with a quantity greater than a preset value is required to be transmitted in one period; data with a volume greater than a preset value or bytes with a quantity greater than a preset value or bits with a quantity greater than a preset value is required to be transmitted in one transmission pattern; data with a volume greater than a first threshold is transmitted in one period; data with a volume less than a second threshold is transmitted in one period; SPS downlink control information is configured or activated; dynamically scheduled downlink control information is configured or activated; a downlink control information configuration is disabled; a downlink resource is a preconfigured resource; triggering or delivery of a new MAC control element is supported; the network or the base station activates or enables delivery of the indication information; delivery of the indication information is supported; a downlink resource includes a plurality of PDSCH resources; a plurality of transmission resources are configured in one transmission period; a plurality of PDSCH resources are included in a preconfigured PDSCH resource pattern; a plurality of PDSCHs are required for data transmission in one period; a plurality of PDSCHs are required for data transmission in a preconfigured PDSCH resource pattern; a volume of data to be transmitted is greater than a transport block size of one PDSCH resource or a specified PDSCH resource; a volume of data to be transmitted is less than a transport block size of all PDSCH resources; a volume of data to be transmitted is greater than a TBS of a plurality of PDSCHs and is less than a TBS of all PDSCHs; a volume of data to be transmitted changes; a resource to be transmitted or a transmission resource to be used changes; a dynamically scheduled resource includes a plurality of PDSCH resources; the third indication information is generated or triggered or pending; a PDCCH carries the third indication information; a DCI format carries a first field (the first field may carry the third indication information); PDSCH-DCI is activated or available (which may carry the third indication information); SPS-DCI is activated or available (which may carry the third indication information); or SPS or a PDSCH may carry the third indication information. In at least one embodiment, the PDCCH or the DCI format may be used to carry dynamic scheduling, or to activate/deactivate SPS, or to activate/deactivate a preconfigured PDSCH, or for other purposes.

In one embodiment, the network device or the base station sends the third indication information to the UE includes by: sending, by the network device or the base station, the third indication information on the first PDSCH resource to the UE, where the third indication information is used to indicate whether to use a resource subsequent to the first PDSCH resource. In at least one embodiment, the first PDSCH may be an SPS PDSCH or a DG PDSCH.

In one embodiment, the resource subsequent to the first PDSCH resource is at least one of the following: a PDSCH resource in a third period; a PDSCH resource in a configured PDSCH resource pattern; a plurality of dynamically scheduled PDSCH resources; a plurality of dynamically scheduled PDSCH resources subsequent to the first PDSCH resource; PDSCH resources in a plurality of periods; PDSCH resources in a plurality of configured PDSCH resource patterns; PDSCH resources in a plurality of periods subsequent to the first PDSCH resource; PDSCH resources in a plurality of configured PDSCH resource patterns subsequent to the first PDSCH resource; a PDSCH resource that is subsequent to the first PDSCH resource and that is in a third period; or a PDSCH resource that is subsequent to the first PDSCH resource and that is in a configured PDSCH resource pattern.

In one embodiment, the resource subsequent to the first PDSCH resource may alternatively be at least one of the following: all of PDSCH resources subsequent to the first PDSCH resource; at least one or a specific quantity of PDSCH resources subsequent to the first PDSCH resource; one PDSCH resource subsequent to the first PDSCH resource; a plurality of consecutive PDSCH resources subsequent to the first PDSCH resource; or a plurality of inconsecutive PDSCH resources subsequent to the first PDSCH resource.

In one embodiment, the foregoing third indication information is used to indicate any one of the following: whether all of resources subsequent to the first PDSCH resource are to be used for data transmission; whether each of resources subsequent to the first PDSCH resource is to be used for data transmission; whether a plurality of resources subsequent to the first PDSCH resource are to be used for data transmission; whether one of resources subsequent to the first PDSCH resource is to be used for data transmission; a specific PDSCH resource in resources subsequent to the first PDSCH resource; a 1^{st} resource subsequent to the first PDSCH resource; a resource, for specific data, closest to the first PUSCH resource and subsequent to the first PDSCH resource; whether each of the target resource is to be used for data transmission; whether one resource or one specific resource in the target resource is to be used for data transmission; whether a plurality of resources or a plurality of specific resources in the target resource are to be used for data transmission; or whether each of the target resource is to be used for data transmission.

In one embodiment, the first PDSCH includes one first PDSCH resource or a plurality of first PDSCH resources, and the third indication information is carried in the one first PDSCH resource or carried in the plurality of first PDSCH resources. In one embodiment, the network device or the base station sends the third indication information to the UE by: sending, by the network device or the base station, the third indication information on one first PDSCH to the UE; sending, by the network device or the base station, the third indication information on a plurality of first PDSCHs to the UE; sending, by the network device or the base station, the third indication information on each PDSCH to the UE; or sending, by the network device or the base station, the third indication information on a specific first PDSCH to the UE. In a case of one first PDSCH resource, the third indication information is carried on the one first PDSCH resource. In a case of a plurality of first PDSCH resources, the third indication information is carried on the plurality of first PDSCH resources, or on at least a part of the plurality of first PDSCH resources. For example, the third indication information may be carried on one PDSCH resource, or the plurality of PDSCH resources may carry respective third indication information. In this embodiment, if the third indication information is carried on one first PDSCH resource, the base station sends the third indication information only on the one first PDSCH. If the third indication information is carried on a plurality of first PDSCH resources, the third indication information may be sent by the UE on the plurality of first PDSCHs, or on each of the plurality of PDSCH, or on a specific first PDSCH, or on each transmitted PDSCH, or on a plurality of transmitted first PDSCHs. In this way, the third indication information is sent in different carrying manners in different cases, so that after receiving the third indication information, the network device or the base station may properly allocate transmission resources in a more targeted and flexible manner, thereby avoiding resource waste.

In one embodiment, the third indication information is further used to indicate at least one of the following: whether a next PDSCH following the first PDSCH is to be used for data transmission; whether all PDSCHs in an SPS period subsequent to the first PDSCH are to be used for data transmission; whether all PDSCHs in a PDSCH resource pattern subsequent to the first PDSCH are to be used for data transmission; or whether a PDSCH at a specified position subsequent to the first PDSCH is to be used for data transmission. The designated position may be one position or a plurality of positions.

In one embodiment, as shown in FIG. 8, the network device or the base station sends the fourth indication information to the UE, where the fourth indication information is carried in a target transmission resource or target transmission information. In at least one embodiment, the network device or the base station sends the fourth indication information to the UE, where the fourth indication information is carried on a target transmission resource or target transmission information before a second PDSCH resource; or the network device or the base station sends the fourth indication information to the UE, where the fourth indication information is sent on a target transmission resource or target transmission information before a second PDSCH resource. In at least one embodiment, the target transmission resource or the target transmission information includes at least one of the following: a PDCCH resource, downlink control information, a scheduling request, a PDSCH, a MAC control element, or radio resource control. In at least one embodiment, there is a fixed offset between the target transmission resource and the second PDSCH resource; or there is a fixed offset between the target transmission resource and a downlink resource configuration, where the downlink resource configuration is a downlink resource configuration corresponding to the second PDSCH resource.

In one embodiment, the second PDSCH resource is at least one of the following: a PDSCH resource before an SPS period; a PDSCH resource before a PDSCH resource pattern; a PDSCH resource before a specific SPS period; a PDSCH resource before a specific PDSCH resource pattern; a PDSCH resource at a 1^{st} position; a PDSCH resource at a specific position; or a plurality of dynamically scheduled PDSCH resources.

In one embodiment, the fourth indication information is used to indicate whether a resource in an SPS period or PDSCH resource pattern is to be used for data transmission; or the fourth indication information is used to indicate whether a plurality of dynamically scheduled PDSCH resources are to be used for data transmission. In at least one embodiment, the resource indicated by the fourth indication information is at least one of the following: a resource in an SPS period or PDSCH resource pattern closest to the target transmission resource or the target transmission information; a resource in one SPS period or PDSCH resource pattern subsequent to the target transmission resource or the target transmission information; a resource in a plurality of SPS periods or PDSCH resource patterns subsequent to the target transmission resource or the target transmission information; a resource in an SPS period or PDSCH resource pattern corresponding to the second PDSCH resource; a resource in a plurality of dynamically scheduled PDSCH resources subsequent to the target transmission resource or the target transmission information; or a resource in a plurality of dynamically scheduled PDSCH resources corresponding to the second PDSCH resource.

In one embodiment, the resource indicated by the fourth indication information further includes at least one of the following: one PDSCH resource in the SPS period or the PDSCH resource pattern; a plurality of PDSCH resources in the SPS period or the PDSCH resource pattern; a specific PDSCH resource in the SPS period or the PDSCH resource pattern; a plurality of consecutive PDSCH resources in the SPS period or the PDSCH resource pattern; a plurality of inconsecutive PDSCH resources in the SPS period or the PDSCH resource pattern; all PDSCH resources in the SPS period or the PDSCH resource pattern; one or more PDSCH resources in the plurality of dynamically scheduled PDSCH resources; a specific PDSCH resource in the plurality of dynamically scheduled PDSCH resources; whether each of the target resource is to be used for data transmission; whether one resource or one specific resource in the target resource is to be used for data transmission; whether a plurality of resources or a plurality of specific resources in the target resource are to be used for data transmission; or whether each of the target resource is to be used for data transmission.

In one embodiment, the fourth indication information is used to indicate any one of the following: whether all of resources in the SPS period or the PDSCH resource pattern are to be used for data transmission; whether each of resources in the SPS period or the PDSCH resource pattern is to be used for data transmission; whether a plurality of resources in the SPS period or the PDSCH resource pattern are to be used for data transmission; whether one of resources in the SPS period or the PDSCH resource pattern is to be used for data transmission; whether a specific one of resources in the SPS period or the PDSCH resource pattern is to be used for data transmission; whether a plurality of resources in the plurality of dynamically scheduled PDSCH resources are to be used for data transmission; whether a specific resource in the plurality of dynamically scheduled PDSCH resources is to be used for data transmission; whether one resource in the plurality of dynamically scheduled PDSCH resources is to be used for data transmission; whether each resource in the plurality of dynamically scheduled PDSCH resources is to be used for data transmission; whether all of the plurality of dynamically scheduled PDSCH resources are to be used for data transmission; whether a next downlink resource is to be used for data transmission; or whether a resource in a fourth period or resource pattern is to be used for data transmission.

In one embodiment, the network device or the base station sends the fourth indication information to the UE by: in a case that a third condition is met, performing at least one of the following: triggering the fourth indication information by the network device or the base station, delivering the fourth indication information by the network device or the base station, or sending the fourth indication information to the UE by the network device or the base station. In at least one embodiment, the third condition includes at least one of the following: data with a volume greater than a preset value or bytes with a quantity greater than a preset value or bits with a quantity greater than a preset value is required to be transmitted in one period; data with a volume greater than a preset value or bytes with a quantity greater than a preset value or bits with a quantity greater than a preset value is required to be transmitted in one transmission pattern; data with a volume greater than a third threshold is transmitted in one period; data with a volume less than a fourth threshold is transmitted in one period; a resource configuration for transmitting the fourth indication information is allowed or disabled; a network or a base station activates or enables delivery of the indication information; delivery of the indication information is supported; triggering or delivery of a new MAC control element is supported; a downlink resource is a preconfigured resource; a downlink resource includes a plurality of PDSCH resources; a plurality of transmission resources are configured in one transmission period; a plurality of PDSCH resources are included in a preconfigured PDSCH resource pattern; a plurality of PDSCHs are required for data transmission in one period; a plurality of PDSCHs are required for data transmission in a preconfigured PDSCH resource pattern; a dynamically scheduled resource includes a plurality of PDSCH resources; the fourth indication information is generated or triggered or pending; a volume of data to be transmitted is greater than a transport block size of one PDSCH resource or a specified PDSCH resource; a volume of data to be transmitted is less than a transport block size of all PDSCH resources; a volume of data to be transmitted is greater than a TBS of a plurality of PDSCHs and less than a TBS of all PDSCHs; a volume of data to be transmitted changes; a resource to be transmitted or a transmission resource to be used changes; there is an available downlink transmission resource; there is an available new transmission resource; a PDCCH carries the fourth indication information; a DCI format carries a first field (the first field may carry the fourth indication information); PDSCH-DCI is activated or available (which may carry the fourth indication information); SPS-DCI is activated or available (which may carry the fourth indication information); or SPS or a PDSCH may carry the fourth indication information. In at least one embodiment, the PDCCH or the DCI format may be used to carry dynamic scheduling, or to activate/deactivate SPS, or to activate/deactivate a preconfigured PDSCH, or for other purposes.

In one embodiment, as shown in FIG. 9, the method further includes: sending, by the network device or the base station, a downlink resource configuration to the UE. In at least one embodiment, the network device or the base station sends the third indication information or the fourth indication information to the UE based on the downlink resource configuration. In at least one embodiment, the downlink resource configuration includes a preconfigured resource or a dynamically scheduled resource. In at least one embodiment, the dynamically scheduled resource includes a plurality of PDSCH resources. In at least one embodiment, the preconfigured resource includes an SPS or a preconfigured PDSCH resource pattern. In at least one embodiment, the downlink resource configuration indicates that a plurality of PDSCH resources are included in one SPS period and/or that a plurality of PDSCH resources are included in one PDSCH resource pattern.

In one embodiment, the downlink resource configuration includes at least one of the following: an SPS index; an SPS period; a quantity of PDSCH resources in an SPS period; resource information of at least one PDSCH resource in one SPS period; downlink control information in one SPS period; downlink control information of an SPS PDSCH resource; a PDSCH resource pattern index; PDSCH resource pattern periodicity or aperiodicity; a quantity of PDSCH resources in a PDSCH resource pattern; resource information of at least one PDSCH resource in one PDSCH resource pattern; downlink control information in one PDSCH resource pattern; downlink control information of a PDSCH resource in a PDSCH resource pattern; downlink control information of a plurality of dynamically scheduled PDSCH resources; information of at least one PDSCH resource in a plurality of dynamically scheduled PDSCH resources; or a quantity of PDSCH resources in a plurality of dynamically scheduled PDSCH resources.

In one embodiment, the resource information of the at least one PDSCH resource includes at least one of the following: a start position of the at least one PDSCH resource; an end position of the at least one PDSCH resource; time domain and frequency domain resource information of the at least one PDSCH resource; a resource offset of each PDSCH resource in the at least one PDSCH resource relative to a 1^{st} PDSCH resource; a resource offset of each PDSCH resource in the at least one PDSCH resource relative to a specific PDSCH resource; a resource offset of each PDSCH resource in the at least one PDSCH resource relative to a last PDSCH resource; a 1^{st} resource or a last resource or a specific resource in the at least one PDSCH resource; a number of the at least one PDSCH resource; redundancy version RV information of the at least one PDSCH resource; an RV offset of each PDSCH resource in the at least one PDSCH resource relative to a 1^{st} PDSCH resource; an RV offset of each PDSCH resource in the at least one PDSCH resource relative to a specific PDSCH resource; an RV offset of each PDSCH resource in the at least one PDSCH resource relative to a last PDSCH resource; hybrid automatic repeat request HARQ process information of the at least one PDSCH resource; a HARQ process information offset of each PDSCH resource in the at least one PDSCH resource relative to a 1^{st} PDSCH resource; a HARQ process information offset of each PDSCH resource in the at least one PDSCH resource relative to a specific PDSCH resource; a HARQ process information offset of each PDSCH resource in the at least one PDSCH resource relative to a last PDSCH resource; a position of a 1^{st} PDSCH resource in the at least one PDSCH resource; a number of a 1^{st} PDSCH resource in the at least one PDSCH resource; a position of a specific PDSCH resource in the at least one PDSCH resource; or a number of a specific PDSCH resource in the at least one PDSCH resource.

In one embodiment, the downlink control information indicates at least one of the following: whether the indication information is included; content of the indication information; a resource carrying the indication information; a PDSCH resource indicated by the indication information; a specified PDSCH resource; a position of the indication information; a size of bytes occupied by the indication information; a disable flag or an enable flag; or a resource status or a resource usage condition.

In one embodiment, the resource status or the resource usage condition includes: that a plurality of PDSCH resources are configured in one SPS period; that a plurality of PDSCH resources are configured in one PDSCH resource pattern; that a plurality of PDSCH resources are used for data transmission; that a volume of data to be transmitted is greater than a transport block size of one PDSCH or a specified PDSCH; or that a volume of data to be transmitted is less than a transport block size of all PDSCHs of a downlink resource.

In one embodiment, the method further includes: performing downlink data transmission by the network device or the base station.

In one embodiment, the network device or the base station performs downlink data transmission by: performing, by the network device or the base station, data transmission on all PDSCH resources; or performing, by the network device or the base station, data transmission on a part of PDSCH resources; or terminating, by the network device or the base station, a part of PDSCH resources.

In one embodiment, the network device or the base station performs data transmission on all PDSCH resources by: performing, by the network device or the base station, data transmission on all PDSCH resources in one SPS period; or performing, by the network device or the base station, data transmission on a PDSCH resource, corresponding to a specific position or index, in one SPS period; or performing, by the network device or the base station, data transmission on all PDSCH resources in one PDSCH resource pattern; or performing, by the network device or the base station, data transmission on a PDSCH resource, corresponding to a specific position or index, in one PDSCH resource pattern; or performing, by the network device or the base station data, transmission on all PDSCH resources in a plurality of dynamically scheduled PDSCH resources; or performing, by the network device or the base station, data transmission on all PDSCH resources, corresponding to a specific position or index, in a plurality of dynamically scheduled PDSCH resources; or performing, by the network device or the base station, data transmission on all PDSCH resources in a plurality of SPS periods; or performing, by the network device or the base station, data transmission on a PDSCH resource, corresponding to a specific position or index, in a plurality of SPS periods; or performing, by the network device or the base station, data transmission on all PDSCH resources in a plurality of PDSCH resource patterns; or performing, by the network device or the base station, data transmission on a PDSCH resource, corresponding to a specific position or index, in a plurality of PDSCH resource patterns.

In one embodiment, the network device or the base station performs data transmission on a part of PDSCH resources by: performing, by the network device or the base station, data transmission on a part of PDSCH resources in one SPS period; or performing, by the network device or the base station, data transmission on a part of PDSCH resources, corresponding to a specific position or index, in one SPS period; or performing, by the network device or the base station, data transmission on a part of PDSCH resources in one PDSCH resource pattern; or performing, by the network device or the base station, data transmission on a part of PDSCH resources, corresponding to a specific position or index, in one PDSCH resource pattern; or performing, by the network device or the base station, data transmission on a part of PDSCH resources in a plurality of dynamically scheduled PDSCH resources; or performing, by the network device or the base station, data transmission on a part of PDSCH resources, corresponding to a specific position or index, in a plurality of dynamically scheduled PDSCH resources; or performing, by the network device or the base station, data transmission on a part of PDSCH resources in a plurality of SPS periods; or performing, by the network device or the base station, data transmission on a part of PDSCH resources, corresponding to a specific position or index, in a plurality of SPS periods; or performing, by the network device or the base station, data transmission on a part of PDSCH resources in a plurality of PDSCH resource patterns; or performing, by the network device or the base station, data transmission on a part of PDSCH resources, corresponding to a specific position or index, in a plurality of PDSCH resource patterns.

In one embodiment, the method further includes: performing, by the network device or the base station, downlink data transmission based on the downlink resource configuration.

In one embodiment, the network device or the base station performs downlink data transmission based on the downlink resource configuration by: performing, by the network device or the base station, data transmission on all PDSCH resources based on the downlink resource configuration; or performing, by the network device or the base station, data transmission on a part of the PDSCH resources based on the downlink resource configuration; or terminating, by the network device or the base station, a part of PDSCH resources based on the downlink resource configuration.

In one embodiment, the network device or the base station performs data transmission on all PDSCH resources based on the downlink resource configuration by: performing, by the network device or the base station, data transmission on all PDSCH resources in one SPS period based on the downlink resource configuration; or performing, by the network device or the base station, data transmission on a PDSCH resource, corresponding to a specific position or index, in one SPS period based on the downlink resource configuration; or performing, by the network device or the base station, data transmission on all PDSCH resources in one PDSCH resource pattern based on the downlink resource configuration; performing, by the network device or the base station, data transmission on a PDSCH resource, corresponding to a specific position or index, in one PDSCH resource pattern based on the downlink resource configuration; or performing, by the network device or the base station, data transmission on all PDSCH resources in a plurality of dynamically scheduled PDSCH resources based on the downlink resource configuration; or performing, by the network device or the base station, data transmission on all PDSCH resources, corresponding to a specific position or index, in a plurality of dynamically scheduled PDSCH resources based on the downlink resource configuration; or performing, by the network device or the base station, data transmission on all PDSCH resources in a plurality of SPS periods based on the downlink resource configuration; or performing, by the network device or the base station, data transmission on a PDSCH resource, corresponding to a specific position or index, in a plurality of SPS periods based on the downlink resource configuration; or performing, by the network device or the base station, data transmission on all PDSCH resources in a plurality of PDSCH resource patterns based on the downlink resource configuration; or performing, by the network device or the base station, data transmission on a PDSCH resource, corresponding to a specific position or index, in a plurality of PDSCH resource patterns based on the downlink resource configuration.

In one embodiment, the network device or the base station performs data transmission on a part of PDSCH resources based on the downlink resource configuration by: performing, by the network device or the base station, data transmission on a part of PDSCH resources in one SPS period based on the downlink resource configuration; or performing, by the network device or the base station, data transmission on a part of PDSCH resources, corresponding to a specific position or index, in one SPS period based on the downlink resource configuration; or performing, by the network device or the base station, data transmission on a part of PDSCH resources in one PDSCH resource pattern based on the downlink resource configuration; or performing, by the network device or the base station, data transmission on a part of PDSCH resources, corresponding to a specific position or index, in one PDSCH resource pattern based on the downlink resource configuration; or performing, by the network device or the base station, data transmission on a part of PDSCH resources in a plurality of dynamically scheduled PDSCH resources based on the downlink resource configuration; or performing, by the network device or the base station, data transmission on a part of PDSCH resources, corresponding to a specific position or index, in a plurality of dynamically scheduled PDSCH resources based on the downlink resource configuration; or performing, by the network device or the base station, data transmission on a part of PDSCH resources in a plurality of SPS periods based on the downlink resource configuration; or performing, by the network device or the base station, data transmission on a part of PDSCH resources, corresponding to a specific position or index, in a plurality of SPS periods based on the downlink resource configuration; or performing, by the network device or the base station, data transmission on a part of PDSCH resources in a plurality of PDSCH resource patterns based on the downlink resource configuration; or performing, by the network device or the base station, data transmission on a part of PDSCH resources, corresponding to a specific position or index, in a plurality of PDSCH resource patterns based on the downlink resource configuration.

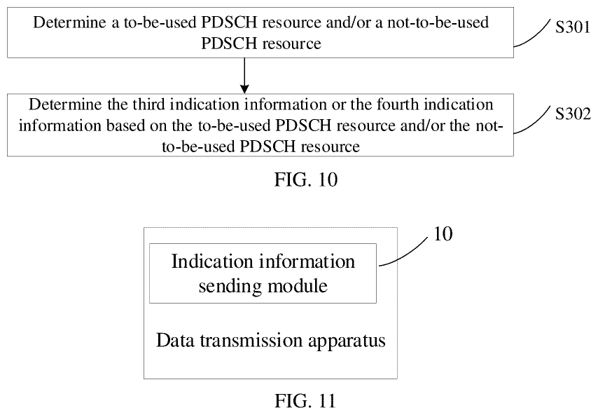

In one embodiment, as shown in FIG. 10, the method further includes at least one of the following:

S301: It is determined a to-be-used PDSCH resource and/or a not-to-be-used PDSCH resource.

S302: It is determined the third indication information or the fourth indication information based on the to-be-used PDSCH resource and/or the not-to-be-used PDSCH resource.

In one embodiment, the method further includes: performing data transmission on the to-be-used PDSCH resource, and/or skipping performing data transmission on the not-to-be-used PDSCH resource, and/or terminating the not-to-be-used PDSCH resource.

In one embodiment, the method further includes: if there is a conflict or multiplexing of PDSCH resources, determining the not-to-be-used PDSCH resource as a low-priority resource.

In one embodiment, the method further includes: determining whether to perform at least one of the following: delivering the third indication information; delivering the fourth indication information; triggering or generating the third indication information; triggering or generating the fourth indication information; triggering delivery of the third indication information; triggering delivery of the fourth indication information; determining whether to terminate a resource; triggering or determining the to-be-used PDSCH resource; triggering or determining transmission of the not-to-be-used PDSCH resource; or triggering the downlink data transmission.

Further, in a case that the UE requests a network to send an indication, the network determines whether to perform at least one of the following: delivering the third indication information; delivering the fourth indication information; triggering or generating the third indication information; triggering or generating the fourth indication information; triggering delivery of the third indication information; triggering delivery of the fourth indication information; determining whether to terminate a resource; triggering or determining the to-be-used PDSCH resource; triggering or determining transmission of the not-to-be-used PDSCH resource; or triggering the downlink data transmission.

In one embodiment, the indication information is used for the UE to perform at least one of the following: determining whether to receive PDSCH transmission; determining a PDSCH required to be received or decoded; determining a PDSCH not required to be received or decoded; or determining a PDSCH required to be terminated.

In this embodiment of this application, for whether to transmit a PDSCH, whether to transmit a target PDSCH is indicated by using a PDCCH or DCI in another implementation.

In at least one embodiment, the base station may use a PDCCH to carry the fourth indication information or the third indication information; or a DCI format carries a first field (the first field may carry the third indication information or the fourth indication information). In at least one embodiment, the PDCCH or the DCI format may be used to carry dynamic scheduling, or to activate/deactivate a CG, or to activate/deactivate a preconfigured PDSCH, or for other purposes. Accordingly, the UE, based on the indication of the base station, determines a to-be-transmitted PDSCH or a not-to-be-transmitted PDSCH and/or performs transmission or dropping.

It should be understood that, although the steps in the flowchart of the embodiments are shown sequentially as indicated by the arrows, these steps are not necessarily performed sequentially in the order indicated by the arrows. Unless otherwise specified in the specification, there is no strict order limitation on execution of these steps, and these steps may be performed in other orders. Moreover, at least some of the steps in the foregoing embodiments may include a plurality of sub-steps or a plurality of stages. These sub-steps or stages are not necessarily performed at the same time, but may be performed at different times. These sub-steps or stages are not necessarily performed in sequence, but may be performed in turn or alternately with at least a part of other steps or sub-steps or stages of other steps.

In addition, embodiments of this application further provide the following different data transmission methods.

Embodiment 1: This embodiment is provided for a process in which a UE indicates first indication information to a network device or a base station, where the first indication information is used to indicate whether to use a subsequent resource. In this embodiment, the first indication information may be sent together with a PUSCH resource (simultaneous indication). Uplink preconfiguration transmission is used as an example for specific implementation of this embodiment, which, however, is also applicable to other uplink PUSCH transmission cases. In addition, in at least one embodiment, logic or implementation of this embodiment is also applicable to the case of transmission of SPS PDSCH or DG PDSCH (corresponding to DL) in which a network sends indication information to indicate the UE of whether to transmit or drop a position. Correspondingly, a channel or information carrying the indication information is a DL channel or DL information. In at least one embodiment, the base station may not send data at the position. In at least one embodiment, the UE determines, based on the indication, whether to perform receiving and/or decoding at the position.
1. The UE receives a UL resource configuration. Specifically, at least one of the following is included:
(a) The UL resource configuration may be a preconfigured resource, for example, a CG configuration, or a preconfigured PUSCH pattern.
(b) For the UL resource configuration, a UL resource includes a plurality of PUSCH resources. For example, there are a plurality of PUSCH resources in one CG period, or there are a plurality of PUSCH resources in one preconfigured PUSCH pattern.
2. The UE performs transmission using a configured UL resource. Specifically, the UE indicates the first indication information to the network (for example, the base station), where the first indication information is used to indicate whether to use a subsequent resource. At least one of the following is included:
(a) The first indication information indicates transmission or dropping.
(b) The first indication information indicates whether to transmit or use a PUSCH resource in a current period, or whether to transmit or use a PUSCH resource in a subsequent period (for example, a next closest period), or whether to transmit or use a subsequent resource in a current preconfigured PUSCH pattern.
(c) The first indication information may be sent together with a PUSCH resource (simultaneous indication). The first indication information is carried in CG-UCI (the CG-UCI is used to transmit the first indication information), or may be carried in a new MAC CE (the MAC CE is used to transmit the first indication information).
(d) The first indication information indicates whether to transmit a subsequent PUSCH, or whether to transmit subsequent consecutive PUSCH resources.
(e) The first indication information is used to indicate whether to transmit a subsequent PUSCH resource in the current period or the current pattern.
(f) The first indication information is carried on a specific PUSCH, for example, a 1^{st} PUSCH, or a certain PUSCH.

i. In at least one embodiment, the first indication information indicates whether to transmit (transmit or drop) another PUSCH (for example, in the current period, in the current pattern, or in a next period) subsequent to a specific PUSCH. The indication may be common (that is, for all related PUSCHs) or may be individually for each PUSCH. The another PUSCH may be one PUSCH or a plurality of PUSCHs.
(g) The first indication information is carried on each PUSCH.
   i. in at least one embodiment, the first indication information indicates whether to transmit a next PUSCH; or
   ii. in at least one embodiment, the first indication information indicates whether to transmit (transmit or drop) another PUSCH (in the current period, in the current pattern, or in a next period) subsequent to a specific PUSCH. The another PUSCH may be a plurality of PUSCHs.
(h) For a PUSCH indicated to be transmitted, the UE performs transmission using the PUSCH.
(i) For a PUSCH indicated to be dropped, the UE performs transmission without using the PUSCH.
(j) In a case that the first condition is met, the UE indicates the first indication information to the network (for example, the base station). The first condition includes at least one of the following: more data or bytes are required to be transmitted in one period; data with a volume greater than a threshold is transmitted in one period; data with a volume less than a threshold is transmitted in one period; a CG-UCI configuration is enabled; a UL resource is a preconfigured resource; triggering or reporting of a new MAC CE is supported; a UL resource includes a plurality of PUSCH resources; a plurality of CG resources are configured in one CG period; a preconfigured PUSCH pattern includes a plurality of PUSCH resources; a plurality of PUSCHs are required to be used in one period; a volume of data to be transmitted is greater than a TBS of one PUSCH or a specific PUSCH (for example, a 1^{st} one); or a volume of data to be transmitted is less than a TBS of all PUSCHs of a UL resource.

In the foregoing embodiment, service transmission requirements of XR or gaming services are ensured. Further, resource waste may be avoided. It should be noted that the foregoing Embodiment 1 uses UL as an example, and all limitations thereof are also applicable to downlink DL. A difference lies in that all uplink channels, configuration periods, scheduling requests, scheduling information, and the like correspond to downlink channels, configuration periods, scheduling requests, scheduling information, and the like.

Embodiment 2: This embodiment is provided for a process in which a UE indicates second indication information to a network, where the second indication information is used to indicate whether to use a subsequent resource. The second indication information may be sent before a PUSCH resource is sent (early indication).

A specific implementation process is as follows (Uplink preconfiguration transmission is used as an example, and the process is also applicable to other uplink PUSCH transmission cases. In addition, in at least one embodiment, logic or implementation of this embodiment is also applicable to the case of transmission of SPS PDSCH or DG PDSCH (corresponding to DL) in which a network sends indication information to indicate the UE of whether to transmit or drop a position. Correspondingly, a channel or information carrying the indication information is a DL channel or DL information. In at least one embodiment, a base station may not send data at the position. In at least one embodiment, the UE, based on the indication, determines whether to perform receiving and/or decoding at the position).
1. The UE receives a UL resource configuration. Specifically, at least one of the following is included:
(a) The UL resource configuration may be a preconfigured resource, for example, a CG configuration or a preconfigured PUSCH pattern.
(b) For the UL resource configuration, a UL resource includes a plurality of PUSCH resources. For example, there are a plurality of PUSCH resources in one CG period, or there are a plurality of PUSCH resources in one preconfigured PUSCH pattern.
2. The UE performs transmission using a configured UL resource. Specifically, the UE indicates the second indication information to the network (for example, the base station), where the second indication information is used to indicate whether to use a subsequent resource. At least one of the following is included:
(a) The second indication information indicates transmission or dropping.
(b) The second indication information indicates whether to transmit or use a PUSCH resource in a current period, or whether to transmit or use a PUSCH resource in a subsequent period (for example, a next closest period), or whether to transmit or use a subsequent resource in a current preconfigured PUSCH pattern.
(c) The second indication information may be sent before a PUSCH resource is sent (early indication). The second indication information is transmitted by using new UCI, or an SR, or a PUSCH. Assuming that there is a PUSCH resource before at least one period of the UL resource, the PUSCH may be used to transmit the second information, for example, a MAC CE or CG-UCI is carried in the PUSCH. The new UCI, or the SR, or the PUSCH is a resource with a fixed offset relative to the UL resource configuration.
(d) The second indication information indicates whether to transmit a closest UL resource, or whether to transmit a PUSCH in a closest period, or whether to transmit a subsequent PUSCH, or whether to transmit subsequent consecutive PUSCH resources.
(e) The second indication information is used to indicate whether to transmit a PUSCH in a closest period or a PUSCH resource of a UL resource configuration. The PUSCH may be one resource or a plurality of PUSCH resources, and the first indication information may be common information, or may be separately for at least one PUSCH. The anther PUSCH may be a PUSCH resource subsequent to a specific PSUCH.
(f) For a PUSCH indicated to be transmitted, the UE performs transmission using the PUSCH
(g) For a PUSCH indicated to be dropped, the UE performs transmission without using the PUSCH.
(h) In a case that a second condition is met, the UE indicates the second indication information to the network (for example, the base station). The second condition includes at least one of the following: more data or bytes are required to be transmitted in one period; data with a volume greater than a threshold is transmitted in one period; data with a volume less than a threshold is transmitted in one period; a resource configuration for transmitting the second indication information is configured or enabled; triggering or reporting of a new MAC CE is supported; a UL resource is a preconfigured resource; a UL resource includes a plurality of PUSCH resources; a plurality of CG resources are configured in one CG period; a preconfigured PUSCH pattern includes a plurality of PUSCH resources; a plurality of PUSCHs are required to be used in one period; a volume of data to be transmitted is greater than a TBS of one PUSCH or a specific PUSCH (for example, a 1^{st} one); or a volume of data to be transmitted is less than a TBS of all PUSCHs of a UL resource.

In the foregoing embodiment, service transmission requirements of XR or gaming services are ensured. Further, resource waste may be avoided. The foregoing Embodiment 2 is similar to the foregoing Embodiment 1, where UL is used as an example for both embodiments, and all limitations thereof are also applicable to downlink DL. A difference lies in that all uplink channels, configuration periods, scheduling requests, scheduling information, and the like correspond to downlink channels, configuration periods, scheduling requests, scheduling information, and the like.

Embodiment 3: This embodiment is provided to describe an implementation process of a resource configuration. (A CG configuration in UL is used as an example. This embodiment may be applicable to downlink SPS, and also applicable to cases of uplink and downlink preconfigured patterns. In at least one embodiment, this embodiment may also be applicable to a case of DG scheduling, for example, a case in which one piece of DCI schedules a plurality of PUSCHs and/or schedules a plurality of PDSCHs; for another example, a case in which one PDCCH schedules a plurality of PUSCHs and/or schedules a plurality of PDSCHs; and for another example, a case in which one PDCCH activates or deactivates a plurality of PUSCHs and/or activates or deactivates a plurality of PDSCHs.)

A plurality of resources, for example, a plurality of PUSCH resources or a plurality of PDSCH resources, are configured in one CG/SPS period. One preconfigured PUSCH pattern also includes a plurality of PUSCH resources, and intervals between the plurality of PUSCH resources may be equal intervals or non-equal intervals. The preconfigured PUSCH pattern may be periodic or aperiodic. In the following implementation, if a preconfigured pattern is used, the following configurations or parameters are required to be modified to adapt to the preconfigured pattern (for example, CG period->preconfigured pattern period).
1. A UE receives a CG configuration, which includes at least one of the following:
(a) The UE receives a CG configuration from a base station. The CG configuration includes at least one of the following:
   i. a CG index;
   ii. a CG period;
   iii. a quantity of resources in a CG period, for example, a quantity of PUSCH or CG PUSCH resources;
   iv. for one CG period, a start position and/or an end position of a plurality of PUSCH or CG PUSCH resources; alternatively, time domain and/or frequency domain resource information of a plurality of PUSCH or CG PUSCH resources, for example, time domain and/or frequency domain resource information of one PUSCH or CG PUSCH resource; an offset of time domain and/or frequency domain resource information of another PUSCH or CG PUSCH resource relative to a 1^{st} PUSCH or CG PUSCH resource; or time domain and/or frequency domain resource information of each PUSCH or CG PUSCH resource;
   v. for a plurality of PUSCH or CG PUSCH resources in one CG period, a PUSCH or CG PSUCH resource serving as a 1^{st} resource, or a PUSCH or CG PSUCH resource serving as a last resource, or a number of each PUSCH or CG PSUCH resource;
   vi. for one CG period, RV information of a plurality of PUSCH or CG PUSCH resources, for example, RV information of each PUSCH or CG PUSCH resource, or RV information of a 1^{st} PUSCH or CG PUSCH resource, and offset information of each subsequent PUSCH or CG PUSCH resource relative to a 1^{st} PUSCH or CG PUSCH resource;
   vii. for one CG period, HARQ process information of a plurality of PUSCH or CG PUSCH resources, for example, HARQ process information of each PUSCH or CG PUSCH resource, or HARQ process information of a 1^{st} PUSCH or CG PUSCH resource and offset information of each subsequent PUSCH or CG PUSCH resource relative to a 1^{st} PUSCH or CG PUSCH resource; or
   viii. for one CG period, CG-UCI configuration information includes at least one of the following:
(1) The CG-UCI configuration information may be for a specific CG PUSCH (for example, a 1^{st} resource, or a last resource, or a resource with a smallest CG PUSCH index in the period), or may be for each CG PUSCH.
(2) A CG UCI configuration includes a position of the first indication information and/or a size of bits occupied by the first indication information.
(3) A CG UCI configuration includes a position of the second indication information and/or a size of bits occupied by the second indication information.
(4) A CG-UCI configuration includes an enable flag or a disable flag, or includes a usage condition. The usage condition is, for example: a plurality of CG resources are configured in one CG period, and/or a plurality of PUSCHs are required to be used, and/or a volume of data to be transmitted is greater than a TBS of one PUSCH or a specific PUSCH, and/or a volume of data to be transmitted is less than a TBS of all PUSCHs of UL resources.
2. The UE performs UL transmission by using a CG configuration includes at least one of the following:
(a) Performing transmission by using all PUSCH resources.
i. Performing transmission by using all PUSCH resources, and performing the transmission for one period, or for the CG index (that is, the CG configuration).
(b) Performing transmission by using a part of PUSCH.
i. Performing transmission by using a part of, and performing the transmission for one period, or for the CG index (that is, the CG configuration).
ii. Determining a to-be-used CG PUSCH resource or a not-to-be-used CG PUSCH, and reporting the to-be-used CG PUSCH resource or the not-to-be-used CG PUSCH to the network device or the base station.

In at least one embodiment, the base station determines, based on the reported information, which CG PUSCH resources are to be used or which PUSCH resources are not to be used. For a CG PUSCH resource that is determined to be used, the base station may receive or decode the CG PUSCH resource. For a CG PUSCH resource that is determined not to be used, the base station may not receive or decode the CG PUSCH resource, or may allocate a position of the resource to another UE or schedule a position of the resource to another UE.
iii. In at least one embodiment, in a case of a conflict or multiplexing of resources, the UE may determine a not-to-be-used resource as a low-priority resource.

In the foregoing embodiment, service transmission requirements of XR or gaming services are ensured. Further, resource waste may be avoided.

In one embodiment, as shown in FIG. 11, an embodiment of this application further provides a data transmission apparatus. The apparatus includes:
an indication information sending module, configured to send indication information, where the indication information is used to indicate whether to use a target resource for data transmission.

In one embodiment, whether to use a target resource for data transmission includes at least one of the following: whether the target resource is to be used for data transmission, whether to terminate the target resource, or whether to use the target resource.

In one embodiment, the indication information is used to indicate at least one of the following: at least one resource in the target resource is to be used for data transmission or is not terminated, all resources in the target resource are to be used for data transmission or are not terminated, at least one resource in the target resource is not to be used for data transmission or is terminated, or all resources in the target resource are not to be used for data transmission or are terminated.

In one embodiment, the target resource is at least one of the following: a resource in a first period; a resource in a second period subsequent to the first period; a resource in a configured PUSCH resource pattern; a resource in one or more periods subsequent to the indication information; a resource in one or more PUSCH resource patterns subsequent to the indication information; a resource in a configured PDSCH resource pattern; a resource in one or more PDSCH resource patterns subsequent to the indication information; one or more configured grant CG resources; one or more CG resources in at least one period; one or more semi-persistent scheduling SPS resources; one or more SPS resources in at least one period; or a dynamically scheduled resource.

In one embodiment, whether to use a target resource for data transmission includes: whether to use the target resource for data sending, and/or whether to use the target resource for data reception.

In one embodiment, the indication information sending module is further configured to perform at least one of the following: sending first indication information, where the first indication information is sent together with a first PUSCH resource; sending second indication information, where the second indication information is sent before a second PUSCH resource; sending first indication information, where the first indication information is sent in a first CG period or in a first PUSCH resource pattern; sending second indication information, where the second indication information is sent in a second CG period or before a second PUSCH resource pattern; sending third indication information, where the third indication information is sent together with a first PDSCH resource; sending fourth indication information, where the fourth indication information is sent before a second PDSCH resource; sending third indication information, the third indication information is sent in a first SPS period or in a first PDSCH resource pattern; sending fourth indication information, where the fourth indication information is sent in a second SPS period or before a second PDSCH resource pattern; sending first indication information, where the first indication information is sent together with a first dynamically scheduled resource; sending second indication information, where the second indication information is sent before a first dynamically scheduled resource; sending third indication information, where the third indication information is sent together with a second dynamically scheduled resource; or sending fourth indication information, where the fourth indication information is sent before a second dynamically scheduled resource.

In one embodiment, the indication information sending module includes a first indication information sending unit, configured to send the first indication information to the network device or the base station.

In one embodiment, the first indication information is carried in at least one of the following: CG uplink control information; a new MAC control element; or a radio resource control message.

In one embodiment, the apparatus further includes a triggering module, configured to: in a case that a first condition is met, trigger generation of the first indication information and/or trigger reporting of the first indication information.

In one embodiment, the first indication information sending unit is further configured to: in a case that the first condition is met and/or in a case that there is an available uplink transmission resource, send the first indication information to the network device or the base station.

In one embodiment, the first condition includes at least one of the following: data with a volume greater than a preset value or bytes with a quantity greater than a preset value or bits with a quantity greater than a preset value is required to be transmitted in one period; data with a volume greater than a preset value or bytes with a quantity greater than a preset value or bits with a quantity greater than a preset value is required to be transmitted in one transmission pattern; data with a volume greater than a first threshold is transmitted in one period; data with a volume less than a second threshold is transmitted in one period; CG uplink control information is configured or activated; DG uplink control information is configured or activated; an uplink control information configuration is disabled; an uplink resource is a preconfigured resource; triggering or reporting of a new MAC control element is supported; a network or a base station activates or enables reporting of the indication information; reporting of the indication information is supported; an uplink resource includes a plurality of PUSCH resources; a plurality of transmission resources are configured in one transmission period; a plurality of PUSCH resources are included in a preconfigured PUSCH resource pattern; a plurality of PUSCHs are required for data transmission in one period; a plurality of PUSCHs are required for data transmission in a preconfigured PUSCH resource pattern; a volume of data to be transmitted is greater than a transport block size of one PUSCH resource or a specified PUSCH resource; a volume of data to be transmitted is less than a transport block size of all PUSCH resources; a volume of data to be transmitted changes; a resource to be transmitted or a transmission resource to be used changes; a dynamically scheduled resource includes a plurality of PUSCH resources; or the first indication information is generated or triggered or pending.

In one embodiment, the first indication information sending unit is further configured to send the first indication information on the first PUSCH resource to the network device or the base station, where the first indication information is used to indicate whether to use the resource subsequent to the first PUSCH resource.

In one embodiment, the resource subsequent to the first PUSCH resource is at least one of the following: a PUSCH resource in a third period; a PUSCH resource in a configured PUSCH resource pattern; a plurality of dynamically scheduled PUSCH resources; a plurality of dynamically scheduled PUSCH resources subsequent to the first PUSCH resource; PUSCH resources in a plurality of periods; PUSCH resources in a plurality of configured PUSCH resource patterns; PUSCH resources in a plurality of periods subsequent to the first PUSCH resource; PUSCH resources in a plurality of configured PUSCH resource patterns subsequent to the first PUSCH resource; a PUSCH resource that is subsequent to the first PUSCH resource and that is in a third period; or a PUSCH resource that is subsequent to the first PUSCH resource and that is in a configured PUSCH resource pattern.

In one embodiment, the resource subsequent to the first PUSCH resource is at least one of the following: all of PUSCH resources subsequent to the first PUSCH resource; at least one or a specific quantity of PUSCH resources subsequent to the first PUSCH resource; one PUSCH resource subsequent to the first PUSCH resource; a plurality of consecutive PUSCH resources subsequent to the first PUSCH resource; or a plurality of inconsecutive PUSCH resources subsequent to the first PUSCH resource.

In one embodiment, the first indication information is used to indicate at least one of the following: whether all of resources subsequent to the first PUSCH resource are to be used for data transmission; whether each of resources subsequent to the first PUSCH resource is to be used for data transmission; whether a plurality of resources subsequent to the first PUSCH resource are to be used for data transmission; whether one of resources subsequent to the first PUSCH resource is to be used for data transmission; a specific PUSCH resource in resources subsequent to the first PUSCH resource; whether each of the target resource is to be used for data transmission; whether one resource or one specific resource in the target resource is to be used for data transmission; whether a plurality of resources or a plurality of specific resources in the target resource are to be used for data transmission; or whether each of the target resource is to be used for data transmission.

In one embodiment, there is one first PUSCH resource or there are a plurality of first PUSCH resources, and the first indication information is carried in the one first PUSCH resource or carried in the plurality of first PUSCH resources.

In one embodiment, the first indication information sending unit is further configured to perform at least one of the following: sending the first indication information on the one first PUSCH to the network device or the base station; sending the first indication information on the plurality of first PUSCHs to the network device or the base station; sending the first indication information on each PUSCH to the network device or the base station; or sending the first indication information on a specific first PUSCH to the network device or the base station.

In one embodiment, the first indication information is used to indicate at least one of the following: whether a next PUSCH following the first PUSCH is to be used for data transmission; whether all PUSCHs in a CG period subsequent to the first PUSCH are to be used for data transmission; whether all PUSCHs in a PUSCH resource pattern subsequent to the first PUSCH are to be used for data transmission; or whether a PUSCH at a specified position subsequent to the first PUSCH is to be used for data transmission.

In one embodiment, the indication information sending module includes a second indication information sending unit, configured to send the second indication information to the network device or the base station, where the second indication information is carried in a target transmission resource or target transmission information.

In one embodiment, the second indication information sending unit is further configured to: send the second indication information to the network device or the base station, where the second indication information is carried on a target transmission resource or target transmission information before the second PUSCH resource; or send the second indication information to the network device or the base station, where the second indication information is sent on a target transmission resource or target transmission information before the second PUSCH resource.

In one embodiment, the second PUSCH resource is at least one of the following: a PUSCH resource before a CG period; a PUSCH resource before a PUSCH resource pattern; a PUSCH resource before a specific CG period; a PUSCH resource before a specific PUSCH resource pattern; a PUSCH resource at a 1^{st} position; a PUSCH resource at a specific position; or a plurality of dynamically scheduled PUSCH resources.

In one embodiment, the target transmission resource or the target transmission information includes at least one of the following: a PUCCH resource, uplink control information, a scheduling request, a PUSCH, a MAC control element, or radio resource control.

In one embodiment, there is a fixed offset between the target transmission resource and the second PUSCH resource; or there is a fixed offset between the target transmission resource and an uplink resource configuration, where the uplink resource configuration is an uplink resource configuration corresponding to the second PUSCH resource.

In one embodiment, the second indication information is used to indicate whether a resource in a CG period or PUSCH resource pattern is to be used for data transmission; or the second indication information is used to indicate whether a plurality of dynamically scheduled PUSCH resources are to be used for data transmission.

In one embodiment, the resource indicated by the second indication information is at least one of the following: a resource in a CG period or PUSCH resource pattern closest to the target transmission resource or the target transmission information; a resource in one CG period or PUSCH resource pattern subsequent to the target transmission resource or the target transmission information; a resource in a plurality of CG periods or PUSCH resource patterns subsequent to the target transmission resource or the target transmission information; a resource in a CG period or PUSCH resource pattern corresponding to the second PUSCH resource; a resource in a plurality of dynamically scheduled PUSCH resources subsequent to the target transmission resource or the target transmission information; or a resource in a plurality of dynamically scheduled PUSCH resources corresponding to the second PUSCH resource.

In one embodiment, the resource indicated by the second indication information includes at least one of the following: one PUSCH resource in the CG period or the PUSCH resource pattern; a plurality of PUSCH resources in the CG period or the PUSCH resource pattern; a specific PUSCH resource in the CG period or the PUSCH resource pattern; a plurality of consecutive PUSCH resources in the CG period or the PUSCH resource pattern; a plurality of inconsecutive PUSCH resources in the CG period or the PUSCH resource pattern; all PUSCH resources in the CG period or the PUSCH resource pattern; one or more PUSCH resources in the plurality of dynamically scheduled PUSCH resources; a specific PUSCH resource in the plurality of dynamically scheduled PUSCH resources; whether each of the target resource is to be used for data transmission; whether one resource or one specific resource in the target resource is to be used for data transmission; whether a plurality of resources or a plurality of specific resources in the target resource are to be used for data transmission; or whether each of the target resource is to be used for data transmission.

In one embodiment, the second indication information is used to indicate any one of the following: whether all of resources in the CG period or the PUSCH resource pattern are to be used for data transmission; whether each of resources in the CG period or the PUSCH resource pattern is to be used for data transmission; whether a plurality of resources in the CG period or the PUSCH resource pattern are to be used for data transmission; whether one of resources in the CG period or the PUSCH resource pattern is to be used for data transmission; whether a specific one of resources in the CG period or the PUSCH resource pattern is to be used for data transmission; whether a plurality of resources in the plurality of dynamically scheduled PUSCH resources are to be used for data transmission; whether a specific resource in the plurality of dynamically scheduled PUSCH resources is to be used for data transmission; whether one resource in the plurality of dynamically scheduled PUSCH resources is to be used for data transmission; whether each resource in the plurality of dynamically scheduled PUSCH resources is to be used for data transmission; whether all of the plurality of dynamically scheduled PUSCH resources are to be used for data transmission; whether a next uplink resource is to be used for data transmission; or whether a resource in a fourth period or resource pattern is to be used for data transmission.

In one embodiment, the second indication information sending unit is further configured to: in a case that a second condition is met, perform at least one of triggering the second indication information, reporting the second indication information, or sending the second indication information to the network device or the base station.

In one embodiment, the second condition includes at least one of the following: data with a volume greater than a preset value or bytes with a quantity greater than a preset value or bits with a quantity greater than a preset value is required to be transmitted in one period; data with a volume greater than a preset value or bytes with a quantity greater than a preset value or bits with a quantity greater than a preset value is required to be transmitted in one transmission pattern; data with a volume greater than a third threshold is transmitted in one period; data with a volume less than a fourth threshold is transmitted in one period; a resource configuration for transmitting the second indication information is allowed or disabled; a network or a base station activates or enables reporting of the indication information; reporting of the indication information is supported; triggering or reporting of a new MAC control element is supported; an uplink resource is a preconfigured resource; an uplink resource includes a plurality of PUSCH resources; a plurality of transmission resources are configured in one transmission period; a plurality of PUSCH resources are included in a preconfigured PUSCH resource pattern; a plurality of PUSCHs are required for data transmission in one period; a plurality of PUSCHs are required for data transmission in a preconfigured PUSCH resource pattern; a dynamically scheduled resource includes a plurality of PUSCH resources; the second indication information is generated or triggered or pending; a volume of data to be transmitted is greater than a transport block size of one PUSCH resource or a specified PUSCH resource; a volume of data to be transmitted is less than a transport block size of all PUSCH resources; a volume of data to be transmitted changes; a resource to be transmitted or a transmission resource to be used changes; there is an available uplink transmission resource; or there is an available new transmission resource.

In one embodiment, the apparatus further includes a receiving module, configured to receive an uplink resource configuration sent by the network device or the base station.

In one embodiment, the receiving module is further configured to send the first indication information or the second indication information to the network device or the base station based on the uplink resource configuration.

In one embodiment, the uplink resource configuration includes a preconfigured resource or a dynamically scheduled resource.

In one embodiment, the dynamically scheduled resource includes a plurality of PUSCH resources.

In one embodiment, the preconfigured resource includes a CG or a preconfigured PUSCH resource pattern.

In one embodiment, the uplink resource configuration indicates that a plurality of PUSCH resources are included in one CG period and/or that a plurality of PUSCH resources are included in one PUSCH resource pattern.

In one embodiment, the uplink resource configuration includes at least one of the following: a CG index: a CG period; a quantity of PUSCH resources in a CG period; resource information of at least one PUSCH resource in one CG period; uplink control information in one CG period; uplink control information of a CG PUSCH resource; a PUSCH resource pattern index; PUSCH resource pattern periodicity or aperiodicity; a quantity of PUSCH resources in a PUSCH resource pattern; resource information of at least one PUSCH resource in one PUSCH resource pattern; uplink control information in one PUSCH resource pattern; uplink control information of a PUSCH resource in a PUSCH resource pattern; uplink control information of a plurality of dynamically scheduled PUSCH resources; information of at least one of a plurality of dynamically scheduled PUSCH resources; or a quantity of PUSCH resources in a plurality of dynamically scheduled PUSCH resources.

In one embodiment, the resource information of the at least one PUSCH resource includes at least one of the following: a start position of the at least one PUSCH resource; an end position of the at least one PUSCH resource; time domain and frequency domain resource information of the at least one PUSCH resource; a resource offset of each PUSCH resource in the at least one PUSCH resource relative to a 1^{st} PUSCH resource; a resource offset of each PUSCH resource in the at least one PUSCH resource relative to a specific PUSCH resource; a resource offset of each PUSCH resource in the at least one PUSCH resource relative to a last PUSCH resource; a 1^{st} resource or a last resource or a specific resource in the at least one PUSCH resource; a number of the at least one PUSCH resource; redundancy version RV information of the at least one PUSCH resource; an RV offset of each PUSCH resource in the at least one PUSCH resource relative to a 1^{st} PUSCH resource; an RV offset of each PUSCH resource in the at least one PUSCH resource relative to a specific PUSCH resource; an RV offset of each PUSCH resource in the at least one PUSCH resource relative to a last PUSCH resource; hybrid automatic repeat request HARQ process information of the at least one PUSCH resource; a HARQ process information offset of each PUSCH resource in the at least one PUSCH resource relative to a 1^{st} PUSCH resource; a HARQ process information offset of each PUSCH resource in the at least one PUSCH resource relative to a specific PUSCH resource; a HARQ process information offset of each PUSCH resource in the at least one PUSCH resource relative to a last PUSCH resource; a position of a 1^{st} PUSCH resource in the at least one PUSCH resource; a number of a 1^{st} PUSCH resource in the at least one PUSCH resource; a position of a specific PUSCH resource in the at least one PUSCH resource; or a number of a specific PUSCH resource in the at least one PUSCH resource.

In one embodiment, the uplink control information indicates at least one of the following: whether the indication information is included; content of the indication information; a resource carrying the indication information; a PUSCH resource indicated by the indication information; a specified PUSCH resource; a position of the indication information; a size of bytes occupied by the indication information; a disable flag or an enable flag; or a resource status or a resource usage condition.

In one embodiment, the resource status or the resource usage condition includes: that a plurality of PUSCH resources are configured in one CG period; that a plurality of PUSCH resources are configured in one PUSCH resource pattern; that a plurality of PUSCH resources are used for data transmission; that a volume of data to be transmitted is greater than a transport block size of one PUSCH or a specified PUSCH; or that a volume of data to be transmitted is less than a transport block size of all PUSCHs of an uplink resource.

In one embodiment, the apparatus further includes an uplink transmission module, configured to perform uplink data transmission based on the uplink resource configuration.

In one embodiment, the uplink transmission module includes a first transmission unit, configured to perform data transmission on all PUSCH resources based on the uplink resource configuration; or a second transmission unit, configured to perform data transmission on a part of PUSCH resources based on the uplink resource configuration or terminate a part of PUSCH resources based on the uplink resource configuration.

In one embodiment, the first transmission unit is further configured to: perform data transmission on all PUSCH resources in one CG period based on the uplink resource configuration; or perform data transmission on a PUSCH resource, corresponding to a specific position or index, in one CG period based on the uplink resource configuration; or perform data transmission on all PUSCH resources in one PUSCH resource pattern based on the uplink resource configuration; or perform data transmission on a PUSCH resource, corresponding to a specific position or index, in one PUSCH resource pattern based on the uplink resource configuration; or perform data transmission on all PUSCH resources in a plurality of dynamically scheduled PUSCH resources based on the uplink resource configuration; or perform data transmission on all PUSCH resources, corresponding to a specific position or index, in a plurality of dynamically scheduled PUSCH resources based on the uplink resource configuration; or perform data transmission on all PUSCH resources in a plurality of CG periods based on the uplink resource configuration; or perform data transmission on a PUSCH resource, corresponding to a specific position or index, in a plurality of CG periods based on the uplink resource configuration; or perform data transmission on all PUSCH resources in a plurality of PUSCH resource patterns based on the uplink resource configuration; or perform data transmission on a PUSCH resource, corresponding to a specific position or index, in a plurality of PUSCH resource patterns based on the uplink resource configuration.

In one embodiment, the second transmission unit is further configured to: perform data transmission on a part of PUSCH resources in one CG period based on the uplink resource configuration; or perform data transmission on a part of PUSCH resources, corresponding to a specific position or index, in one CG period based on the uplink resource configuration; or perform data transmission on a part of PUSCH resources in one PUSCH resource pattern based on the uplink resource configuration; or perform data transmission on a part of PUSCH resources, corresponding to a specific position or index, in one PUSCH resource pattern based on the uplink resource configuration; or perform data transmission on a part of PUSCH resources in a plurality of dynamically scheduled PUSCH resources based on the uplink resource configuration; or perform data transmission on a part of PUSCH resources, corresponding to a specific position or index, in a plurality of dynamically scheduled PUSCH resources based on the uplink resource configuration; or perform data transmission on a part of PUSCH resources in a plurality of CG periods based on the uplink resource configuration; or perform data transmission on a part of PUSCH resources, corresponding to a specific position or index, in a plurality of CG periods based on the uplink resource configuration; or perform data transmission on a part of PUSCH resources in a plurality of PUSCH resource patterns based on the uplink resource configuration; or perform data transmission on a part of PUSCH resources, corresponding to a specific position or index, in a plurality of PUSCH resource patterns based on the uplink resource configuration.

In one embodiment, the apparatus further includes a first determining module, configured to: determine a to-be-used PUSCH resource and/or a not-to-be-used PUSCH resource; and determine the first indication information or the second indication information based on the to-be-used PUSCH resource and/or the not-to-be-used PUSCH resource.

In one embodiment, the apparatus further includes a first execution module, configured to perform data transmission on the to-be-used PUSCH resource, and/or skip performing data transmission on the not-to-be-used PUSCH resource, and/or terminate the not-to-be-used PUSCH resource.

In one embodiment, the apparatus further includes a second determining module, configured to: if there is a conflict or multiplexing of PUSCH resources, determine the not-to-be-used PUSCH resource as a low-priority resource.

In one embodiment, the apparatus further includes a third determining module: configured to determine, based on an indication of the network device or the base station, whether to perform at least one of the following: reporting the first indication information; reporting the second indication information; triggering or generating the first indication information; triggering or generating the second indication information; triggering reporting of the first indication information; triggering reporting of the second indication information; determining whether to terminate a resource; triggering or determining the to-be-used PUSCH resource; triggering or determining transmission of the not-to-be-used PUSCH resource; or triggering the uplink data transmission.

In one embodiment, the indication information is used to instruct the network or the base station to perform at least one of the following: determining whether to receive PUSCH transmission; determining a PUSCH required to be received or decoded; determining a PUSCH not required to be received or decoded; or determining a PUSCH required to be terminated.

In one embodiment, the indication information sending module includes a third indication information sending unit, configured to send the third indication information to the UE.

In one embodiment, the third indication information is carried in at least one of the following: a PDCCH; SPS; a downlink dynamically scheduled PDSCH; SPS downlink control information; a new MAC control element; or a radio resource control message.

In one embodiment, the third indication information sending unit is further configured to: in a case that a third condition is met, trigger generation of the third indication information, and/or trigger delivery of the third indication information.

In one embodiment, the third indication information sending unit is further configured to: in a case that the third condition is met and/or in a case that there is an available downlink transmission resource, send the third indication information to the UE.

In one embodiment, the third condition includes at least one of the following: data with a volume greater than a preset value or bytes with a quantity greater than a preset value or bits with a quantity greater than a preset value is required to be transmitted in one period; data with a volume greater than a preset value or bytes with a quantity greater than a preset value or bits with a quantity greater than a preset value is required to be transmitted in one transmission pattern; data with a volume greater than a first threshold is transmitted in one period; data with a volume less than a second threshold is transmitted in one period; SPS downlink control information is configured or activated; dynamically scheduled downlink control information is configured or activated; a downlink control information configuration is disabled; a downlink resource is a preconfigured resource; triggering or delivery of a new MAC control element is supported; a network or a base station activates or enables delivery of the indication information; delivery of the indication information is supported; a downlink resource includes a plurality of PDSCH resources; a plurality of transmission resources are configured in one transmission period; a plurality of PDSCH resources are included in a preconfigured PDSCH resource pattern; a plurality of PDSCHs are required for data transmission in one period; a plurality of PDSCHs are required for data transmission in a preconfigured PDSCH resource pattern; a volume of data to be transmitted is greater than a transport block size of one PDSCH resource or a specified PDSCH resource; a volume of data to be transmitted is less than a transport block size of all PDSCH resources; a volume of data to be transmitted changes; a resource to be transmitted or a transmission resource to be used changes; a dynamically scheduled resource includes a plurality of PDSCH resources; or the third indication information is generated or triggered or pending.

In one embodiment, the third indication information sending unit is further configured to send the third indication information on the first PDSCH resource to the UE, where the third indication information is used to indicate whether to use the resource subsequent to the first PDSCH resource.

In one embodiment, the resource subsequent to the first PDSCH resource is at least one of the following: a PDSCH resource in a third period; a PDSCH resource in a configured PDSCH resource pattern; a plurality of dynamically scheduled PDSCH resources; a plurality of dynamically scheduled PDSCH resources subsequent to the first PDSCH resource; PDSCH resources in a plurality of periods; PDSCH resources in a plurality of configured PDSCH resource patterns; PDSCH resources in a plurality of periods subsequent to the first PDSCH resource; PDSCH resources in a plurality of configured PDSCH resource patterns subsequent to the first PDSCH resource; a PDSCH resource that is subsequent to the first PDSCH resource and that is in a third period; or a PDSCH resource that is subsequent to the first PDSCH resource and that is in a configured PDSCH resource pattern.

In one embodiment, the resource subsequent to the first PDSCH resource is at least one of the following: all of PDSCH resources subsequent to the first PDSCH resource; at least one or a specific quantity of PDSCH resources subsequent to the first PDSCH resource; one PDSCH resource subsequent to the first PDSCH resource; a plurality of consecutive PDSCH resources subsequent to the first PDSCH resource; or a plurality of inconsecutive PDSCH resources subsequent to the first PDSCH resource.

In one embodiment, the third indication information is used to indicate any one of the following: whether all of resources subsequent to the first PDSCH resource are to be used for data transmission; whether each of resources subsequent to the first PDSCH resource is to be used for data transmission; whether a plurality of resources subsequent to the first PDSCH resource are to be used for data transmission; whether one of resources subsequent to the first PDSCH resource is to be used for data transmission; a specific PDSCH resource in resources subsequent to the first PDSCH resource; whether each of the target resource is to be used for data transmission; whether one resource or one specific resource in the target resource is to be used for data transmission; whether a plurality of resources or a plurality of specific resources in the target resource are to be used for data transmission; or whether each of the target resource is to be used for data transmission.

In one embodiment, there is one first PDSCH resources or there are a plurality of first PDSCH resources, and the third indication information is carried in the one first PDSCH resource or carried in the plurality of first PDSCH resources.

In one embodiment, the third indication information sending unit is further configured to: send the third indication information on one first PDSCH to the UE; send the third indication information on a plurality of first PDSCHs to the UE; send the third indication information on each PDSCH to the UE; or send the third indication information on a specific first PDSCH to the UE.

In one embodiment, the third indication information is further used to indicate at least one of the following: whether a next PDSCH following the first PDSCH is to be used for data transmission; whether all PDSCHs in an SPS period subsequent to the first PDSCH are to be used for data transmission; whether all PDSCHs in a PDSCH resource pattern subsequent to the first PDSCH are to be used for data transmission; or whether a PDSCH at a specified position subsequent to the first PDSCH is to be used for data transmission.

In one embodiment, the indication information sending module includes a fourth indication information sending unit, configured to send the fourth indication information to the UE, where the fourth indication information is carried in a target transmission resource or target transmission information.

In one embodiment, the fourth indication information sending unit is further configured to: send the fourth indication information to the UE, where the fourth indication information is carried in a target transmission resource or target transmission information before the second PDSCH resource; or send the fourth indication information to the UE, where the fourth indication information is sent on a target transmission resource or target transmission information before the second PDSCH resource.

In one embodiment, the second PDSCH resource is at least one of the following: a PDSCH resource before an SPS period; a PDSCH resource before a PDSCH resource pattern; a PDSCH resource before a specific SPS period; a PDSCH resource before a specific PDSCH resource pattern; a PDSCH resource at a 1^{st} position; a PDSCH resource at a specific position; or a plurality of dynamically scheduled PDSCH resources.

In one embodiment, the target transmission resource or the target transmission information includes at least one of the following: a PDCCH resource, downlink control information, a scheduling request, a PDSCH, a MAC control element, or radio resource control.

In one embodiment, there is a fixed offset between the target transmission resource and the second PDSCH resource; or there is a fixed offset between the target transmission resource and a downlink resource configuration, where the downlink resource configuration is a downlink resource configuration corresponding to the second PDSCH resource.

In one embodiment, the fourth indication information is used to indicate whether a resource in an SPS period or PDSCH resource pattern is to be used for data transmission; or the fourth indication information is used to indicate whether a plurality of dynamically scheduled PDSCH resources are to be used for data transmission.

In one embodiment, the resource indicated by the fourth indication information is at least one of the following: a resource in an SPS period or PDSCH resource pattern closest to the target transmission resource or the target transmission information; a resource in one SPS period or PDSCH resource pattern subsequent to the target transmission resource or the target transmission information; a resource in a plurality of SPS periods or PDSCH resource patterns subsequent to the target transmission resource or the target transmission information; a resource in an SPS period or PDSCH resource pattern corresponding to the second PDSCH resource; a resource in a plurality of dynamically scheduled PDSCH resources subsequent to the target transmission resource or the target transmission information; or a resource in a plurality of dynamically scheduled PDSCH resources corresponding to the second PDSCH resource.

In one embodiment, the resource indicated by the fourth indication information includes at least one of the following: one PDSCH resource in the SPS period or the PDSCH resource pattern; a plurality of PDSCH resources in the SPS period or the PDSCH resource pattern; a specific PDSCH resource in the SPS period or the PDSCH resource pattern; a plurality of consecutive PDSCH resources in the SPS period or the PDSCH resource pattern; a plurality of inconsecutive PDSCH resources in the SPS period or the PDSCH resource pattern; all PDSCH resources in the SPS period or the PDSCH resource pattern; one or more PDSCH resources in the plurality of dynamically scheduled PDSCH resources; a specific PDSCH resource in the plurality of dynamically scheduled PDSCH resources; whether each of the target resource is to be used for data transmission; whether one resource or one specific resource in the target resource is to be used for data transmission; whether a plurality of resources or a plurality of specific resources in the target resource are to be used for data transmission; or whether each of the target resource is to be used for data transmission.

In one embodiment, the fourth indication information is used to indicate any one of the following: whether all of resources in the SPS period or the PDSCH resource pattern are to be used for data transmission; whether each of resources in the SPS period or the PDSCH resource pattern is to be used for data transmission; whether a plurality of resources in the SPS period or the PDSCH resource pattern are to be used for data transmission; whether one of resources in the SPS period or the PDSCH resource pattern is to be used for data transmission; whether a specific one of resources in the SPS period or the PDSCH resource pattern is to be used for data transmission; whether a plurality of resources in the plurality of dynamically scheduled PDSCH resources are to be used for data transmission; whether a specific resource in the plurality of dynamically scheduled PDSCH resources is to be used for data transmission; whether one resource in the plurality of dynamically scheduled PDSCH resources is to be used for data transmission; whether each resource in the plurality of dynamically scheduled PDSCH resources is to be used for data transmission; whether all of the plurality of dynamically scheduled PDSCH resources are to be used for data transmission; whether a next downlink resource is to be used for data transmission; or whether a resource in a fourth period or resource pattern is to be used for data transmission.

In one embodiment, the fourth indication information sending unit is further configured to: in a case that a fourth condition is met, perform at least one of triggering the fourth indication information, delivery the fourth indication information, or send the fourth indication information to the UE.

In one embodiment, the fourth condition includes at least one of the following: data with a volume greater than a preset value or bytes with a quantity greater than a preset value or bits with a quantity greater than a preset value is required to be transmitted in one period; data with a volume greater than a preset value or bytes with a quantity greater than a preset value or bits with a quantity greater than a preset value is required to be transmitted in one transmission pattern; data with a volume greater than a third threshold is transmitted in one period; data with a volume less than a fourth threshold is transmitted in one period; a resource configuration for transmitting the fourth indication information is allowed or disabled; a network or a base station activates or enables delivery of the indication information; delivery of the indication information is supported; triggering or delivery of a new MAC control element is supported; a downlink resource is a preconfigured resource; a downlink resource includes a plurality of PDSCH resources; a plurality of transmission resources are configured in one transmission period; a plurality of PDSCH resources are included in a preconfigured PDSCH resource pattern; a plurality of PDSCHs are required for data transmission in one period; a plurality of PDSCHs are required for data transmission in a preconfigured PDSCH resource pattern; a dynamically scheduled resource includes a plurality of PDSCH resources; the fourth indication information is generated or triggered or pending; a volume of data to be transmitted is greater than a transport block size of one PDSCH resource or a specified PDSCH resource; a volume of data to be transmitted is less than a transport block size of all PDSCH resources; a volume of data to be transmitted changes; a resource to be transmitted or a transmission resource to be used changes; there is an available downlink transmission resource; or there is an available new transmission resource.

In one embodiment, the apparatus further includes a configuration sending module, configured to send the downlink resource configuration to the UE.

In one embodiment, the configuration sending module is further configured to send the third indication information or the fourth indication information to the UE based on the downlink resource configuration.

In one embodiment, the downlink resource configuration includes a preconfigured resource or a dynamically scheduled resource.

In one embodiment, the dynamically scheduled resource includes a plurality of PDSCH resources.

In one embodiment, the preconfigured resource includes an SPS or a preconfigured PDSCH resource pattern.

In one embodiment, the downlink resource configuration indicates that a plurality of PDSCH resources are included in one SPS period and/or that a plurality of PDSCH resources are included in one PDSCH resource pattern.

In one embodiment, the downlink resource configuration includes at least one of the following: an SPS index: an SPS period; a quantity of PDSCH resources in an SPS period; resource information of at least one PDSCH resource in one SPS period; downlink control information in one SPS period; downlink control information of an SPS PDSCH resource; a PDSCH resource pattern index; PDSCH resource pattern periodicity or aperiodicity; a quantity of PDSCH resources in a PDSCH resource pattern; resource information of at least one PDSCH resource in one PDSCH resource pattern; downlink control information in one PDSCH resource pattern; downlink control information of a PDSCH resource in a PDSCH resource pattern; downlink control information of a plurality of dynamically scheduled PDSCH resources; information of at least one PDSCH resource in a plurality of dynamically scheduled PDSCH resources; or a quantity of PDSCH resources in a plurality of dynamically scheduled PDSCH resources.

In one embodiment, the resource information of the at least one PDSCH resource includes at least one of the following: a start position of the at least one PDSCH resource; an end position of the at least one PDSCH resource; time domain and frequency domain resource information of the at least one PDSCH resource; a resource offset of each PDSCH resource in the at least one PDSCH resource relative to a 1^{st} PDSCH resource; a resource offset of each PDSCH resource in the at least one PDSCH resource relative to a specific PDSCH resource; a resource offset of each PDSCH resource in the at least one PDSCH resource relative to a last PDSCH resource; a 1^{st} resource or a last resource or a specific resource in the at least one PDSCH resource; a number of the at least one PDSCH resource; redundancy version RV information of the at least one PDSCH resource; an RV offset of each PDSCH resource in the at least one PDSCH resource relative to a 1^{st} PDSCH resource; an RV offset of each PDSCH resource in the at least one PDSCH resource relative to a specific PDSCH resource; an RV offset of each PDSCH resource in the at least one PDSCH resource relative to a last PDSCH resource; hybrid automatic repeat request HARQ process information of the at least one PDSCH resource; a HARQ process information offset of each PDSCH resource in the at least one PDSCH resource relative to a 1^{st} PDSCH resource; a HARQ process information offset of each PDSCH resource in the at least one PDSCH resource relative to a specific PDSCH resource; a HARQ process information offset of each PDSCH resource in the at least one PDSCH resource relative to a last PDSCH resource; a position of a 1^{st} PDSCH resource in the at least one PDSCH resource; a number of a 1^{st} PDSCH resource in the at least one PDSCH resource; a position of a specific PDSCH resource in the at least one PDSCH resource; or a number of a specific PDSCH resource in the at least one PDSCH resource.

In one embodiment, the downlink control information indicates at least one of the following: whether the indication information is included; content of the indication information; a resource carrying the indication information; a PDSCH resource indicated by the indication information; a specified PDSCH resource; a position of the indication information; a size of bytes occupied by the indication information; a disable flag or an enable flag; or a resource status or a resource usage condition.

In one embodiment, the resource status or the resource usage condition includes: that a plurality of PDSCH resources are configured in one SPS period; that a plurality of PDSCH resources are configured in one PDSCH resource pattern; that a plurality of PDSCH resources are used for data transmission; that a volume of data to be transmitted is greater than a transport block size of one PDSCH or a specified PDSCH; or that a volume of data to be transmitted is less than a transport block size of all PDSCHs of a downlink resource.

In one embodiment, the apparatus further includes a downlink transmission module, configured to perform downlink data transmission, or perform downlink data transmission based on the downlink resource configuration.

In one embodiment, the downlink transmission module includes a third transmission unit, configured to perform downlink data transmission on all PDSCH resources or perform data transmission on all PDSCH resources based on the downlink resource configuration; or a fourth transmission unit, configured to perform downlink data transmission on a part of PDSCH resources or perform data transmission on a part of PDSCH resources based on the downlink resource configuration; or a fifth transmission unit, configured to terminate a part of PDSCH resources based on the downlink resource configuration.

In one embodiment, the third transmission unit is further configured to: perform data transmission on all PDSCH resources in one SPS period, or perform data transmission on all PDSCH resources in one SPS period based on the downlink resource configuration; or perform data transmission on a PDSCH resource, corresponding to a specific position or index, in one SPS period, or perform data transmission on a PDSCH resource, corresponding to a specific position or index, in one SPS period based on the downlink resource configuration; or perform data transmission on all PDSCH resources in one PDSCH resource pattern, or perform data transmission on all PDSCH resources in one PDSCH resource pattern based on the downlink resource configuration; or perform data transmission on a PDSCH resource, corresponding to a specific position or index, in one PDSCH resource pattern, or perform data transmission on a PDSCH resource, corresponding to a specific position or index, in one PDSCH resource pattern based on the downlink resource configuration; or perform data transmission on all PDSCH resources in a plurality of dynamically scheduled PDSCH resources, or perform data transmission on all PDSCH resources in a plurality of dynamically scheduled PDSCH resources based on the downlink resource configuration; or perform data transmission on all PDSCH resources, corresponding to a specific position or index, in a plurality of dynamically scheduled PDSCH resources, or perform data transmission on all PDSCH resources, corresponding to a specific position or index, in a plurality of dynamically scheduled PDSCH resources based on the downlink resource configuration; or perform data transmission on all PDSCH resources in a plurality of SPS periods, or perform data transmission on all PDSCH resources in a plurality of SPS periods based on the downlink resource configuration; or perform data transmission on a PDSCH resource, corresponding to a specific position or index, in a plurality of SPS periods, or perform data transmission on a PDSCH resource, corresponding to a specific position or index, in a plurality of SPS periods based on the downlink resource configuration; or perform data transmission on all PDSCH resources in a plurality of PDSCH resource patterns, or perform data transmission on all PDSCH resources in a plurality of PDSCH resource patterns based on the downlink resource configuration; or perform data transmission on a PDSCH resource, corresponding to a specific position or index, in a plurality of PDSCH resource patterns, or perform data transmission on a PDSCH resource, corresponding to a specific position or index, in a plurality of PDSCH resource patterns based on the downlink resource configuration.

In one embodiment, the fourth transmission unit is further configured to: perform data transmission on a part of PDSCH resources in one SPS period; or perform data transmission on a part of PDSCH resources in one SPS period based on the downlink resource configuration; or perform data transmission on a part of PDSCH resources, corresponding to a specific position or index, in one SPS period; or perform data transmission on a part of PDSCH resources, corresponding to a specific position or index, in one SPS period based on the downlink resource configuration; or perform data transmission on a part of PDSCH resources in one PDSCH resource pattern; or perform data transmission on a part of PDSCH resources in one PDSCH resource pattern based on the downlink resource configuration; or perform data transmission on a part of PDSCH resources, corresponding to a specific position or index, in one PDSCH resource pattern; or perform data transmission on a part of PDSCH resources, corresponding to a specific position or index, in one PDSCH resource pattern based on the downlink resource configuration; or perform data transmission on a part of PDSCH resources in a plurality of dynamically scheduled PDSCH resources; or perform data transmission on a part of PDSCH resources in a plurality of dynamically scheduled PDSCH resources based on the downlink resource configuration; or perform data transmission on a part of PDSCH resources, corresponding to a specific position or index, in a plurality of dynamically scheduled PDSCH resources; or perform data transmission on a part of PDSCH resources, corresponding to a specific position or index, in a plurality of dynamically scheduled PDSCH resources based on the downlink resource configuration; or perform data transmission on a part of PDSCH resources in a plurality of SPS periods; or perform data transmission on a part of PDSCH resources in a plurality of SPS periods based on the downlink resource configuration; or perform data transmission on a part of PDSCH resources, corresponding to a specific position or index, in a plurality of SPS periods; or perform data transmission on a part of PDSCH resources, corresponding to a specific position or index, in a plurality of SPS periods based on the downlink resource configuration; or perform data transmission on a part of PDSCH resources in a plurality of PDSCH resource patterns; or perform data transmission on a part of PDSCH resources in a plurality of PDSCH resource patterns based on the downlink resource configuration; or perform data transmission on a part of PDSCH resources, corresponding to a specific position or index, in a plurality of PDSCH resource patterns; or perform data transmission on a part of PDSCH resources, corresponding to a specific position or index, in a plurality of PDSCH resource patterns based on the downlink resource configuration.

In one embodiment, the apparatus further includes a fourth determining module, configured to: determine a to-be-used PDSCH resource and/or a not-to-be-used PDSCH resource; and determine the third indication information or the fourth indication information based on the to-be-used PDSCH resource and/or the not-to-be-used PDSCH resource.

In one embodiment, the apparatus further includes: a second execution module, configured to perform data transmission on the to-be-used PDSCH resource, and/or skip performing data transmission on the not-to-be-used PDSCH resource, and/or terminate the not-to-be-used PDSCH resource.

In one embodiment, the apparatus further includes a fifth determining module, configured to: if there is a conflict or multiplexing of PDSCH resources, determine the not-to-be-used PDSCH resource as a low-priority resource.

In one embodiment, the apparatus further includes a sixth determining module: configured to determine whether to perform at least one of the following: delivering the third indication information; delivering the fourth indication information; triggering or generating the third indication information; triggering or generating the fourth indication information; triggering delivery of the third indication information; triggering delivery of the fourth indication information; determining whether to terminate a resource; triggering or determining the to-be-used PDSCH resource; triggering or determining transmission of the not-to-be-used PDSCH resource; or triggering the downlink data transmission.

In one embodiment, the indication information is used for the UE to perform at least one of the following: determining whether to receive PDSCH transmission; determining a PDSCH required to be received or decoded; determining a PDSCH not required to be received or decoded; or determining a PDSCH required to be terminated.

For specific limitations on the data transmission apparatus, reference may be made to the limitations on the data transmission method described above. Details are not described herein again. All or some of the modules in the foregoing data transmission apparatus may be implemented by software, hardware, or a combination thereof. The foregoing modules may be embedded in or independent of a processor in a computer device in the form of hardware, or may be stored in a memory in a computer device in the form of software, so that the processor may invoke and execute operations corresponding to the foregoing modules.

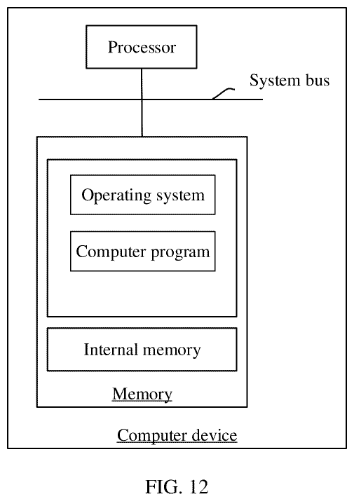

In one embodiment, a computer device is provided. The computer device may be a server, and an internal structure of the computer device may be as shown in FIG. 12. The computer device includes a processor, a memory, a network interface, and a database that are connected through a system bus. The processor of the computer device is configured to provide computing and control functions. The memory of the computer device includes a non-volatile storage medium and an internal memory. The non-volatile storage medium stores an operating system, a computer program, and a database. The internal memory provides an environment for operation of the operating system and the computer program in the non-volatile storage medium. The database of the computer device is configured to store data for data transmission. The network interface of the computer device is configured to communicate with an external terminal through a network connection. When the computer program is executed by the processor, a data transmission method is implemented.

A person skilled in the art may understand that the structure shown in FIG. 12 is merely a block diagram of a partial structure related to the solutions of this application, and does not constitute a limitation on the computer device to which the solutions of this application are applied. A specific computer device may include more or fewer components than those shown in the figure, or have some components combined, or have a different component arrangement.

In one embodiment, a computer device is provided, including a memory and a processor, where a computer program is stored in the memory, and when the processor executes the computer program, the following step is implemented:
sending indication information, where the indication information is used to indicate whether to use a target resource for data transmission.

Implementation principles and technical effects of the computer device provided in the foregoing embodiment are similar to those of the foregoing method embodiments. Details are not described herein again.

In one embodiment, a computer-readable storage medium is provided, where a computer program is stored in the computer-readable storage medium, and when the computer program is executed by a processor, the following step is implemented:
sending indication information, where the indication information is used to indicate whether to use a target resource for data transmission.

Implementation principles and technical effects of the computer-readable storage medium provided in the foregoing embodiment are similar to those of the foregoing method embodiments. Details are not described herein again.

In one embodiment, a computer program product is provided, where a computer program is stored in the computer program product, and when the computer program is executed by a processor, the following step is implemented:
sending indication information, where the indication information is used to indicate whether to use a target resource for data transmission.

Implementation principles and technical effects of the computer program product provided in the foregoing embodiment are similar to those of the foregoing method embodiments. Details are not described herein again.

A person of ordinary skill in the art may understand that all or some of the procedures of the method in the above embodiments may be implemented by instructing related hardware by a computer program. The computer program may be stored in a non-volatile computer-readable storage medium. When the computer program is executed, processes of the method embodiments may be included. Any reference to the memory, storage, database or other media used in embodiments provided in this application may include a non-volatile and/or volatile memory. The non-volatile memory may include a read-only memory (ROM), a programmable ROM (PROM), an electrically programmable ROM (EPROM), an electrically erasable programmable ROM (EEPROM), or a flash memory. The volatile memory may include a random access memory (RAM) or an external cache. By way of illustration but not limitation, the RAM is available in a plurality of forms, such as static RAM (SRAM), dynamic RAM (DRAM), synchronous DRAM (SDRAM), double data rate SDRAM (DDRSDRAM), enhanced SDRAM (ESDRAM), synchlink DRAM (SLDRAM), Rambus (Rambus) direct RAM (RDRAM), direct Rambus dynamic RAM (DRDRAM), and Rambus dynamic RAM (RDRAM).

The technical features of the foregoing embodiments may be combined randomly. For brevity of description, not all possible combinations of the technical features in the foregoing embodiments are described. However, provided no conflict occurs when the technical features are combined, it should be considered that a combination of the technical features falls within the scope of the disclosure of this specification. The foregoing embodiments merely illustrate implementations of this application, and the description thereof is relatively specific and detailed, but it should not be construed as a limitation on the scope of this application. It should be noted that a person of ordinary skill in the art may make several variants and improvements without departing from the concept of this application and the variants and improvements shall fall within the protection scope of this application. Therefore, the protection scope of this application shall be subject to the protection scope of the claims.

What is claimed is:

1. A data transmission method, wherein the method comprises:
sending, by a first device, indication information to a second device, wherein the first device is a user equipment (UE), the second device is a network device or a base station, the indication information is used to indicate whether to use a target resource for data transmission.

2. A data transmission apparatus, comprising a memory and a processor, wherein the memory is configured to store a program, and the processor is configured to invoke the program in the memory, to cause the data transmission apparatus to perform:
sending, by a first device, indication information to a second device, wherein the first device is a user equipment (UE), the second device is a network device or a base station, the indication information is used to indicate whether to use a target resource for data transmission.

3. The apparatus according to claim 2, wherein
the indication information is used to indicate at least one of following:
at least one resource of the target resource is to be used for data transmission or is not to be terminated;
all resources of the target resource are to be used for data transmission or are not to be terminated;
at least one resource of the target resource is not to be used for data transmission or is to be terminated; or
all resources of the target resource are not to be used for data transmission or are to be terminated; or
the target resource is at least one of following:
a resource in a first period;
a resource in a second period subsequent to the first period;
a resource in a configured physical uplink shared channel (PUSCH) resource pattern;
a resource in one or more periods subsequent to the indication information;
a resource in one or more PUSCH resource patterns subsequent to the indication information;
one or more configured grant (CG) resources;
one or more CG resources in at least one period.

4. The apparatus according to claim 2, wherein the sending, by a first device, indication information to a second device comprises at least one of following:
sending, by the first device, first indication information to the second device, wherein the first indication information is sent together with a first PUSCH resource;
sending, by the first device, second indication information to the second device, wherein the second indication information is sent before a second PUSCH resource;
sending, by the first device, first indication information to the second device, wherein the first indication information is sent in a first CG period or in a first PUSCH resource pattern;
sending, by the first device, second indication information to the second device, wherein the second indication information is sent in a second CG period or before a second PUSCH resource pattern.

5. The apparatus according to claim 4, wherein the first indication information is carried in:
CG uplink control information (CG-UCI).

6. The apparatus according to claim 2, wherein the method further comprises:
in a case that a first condition is met, generating the first indication information, and/or reporting the first indication information.

7. The apparatus according to claim 6, wherein the first condition comprises:
that CG-UCI is configured or activated.

8. The apparatus according to claim 7, wherein that the CG-UCI is configured or activated means that UCI information carried on a CG is used to transmit the indication information.

9. The apparatus according to claim 4, wherein
the sending, by the first device, first indication information to the second device comprises:
sending, by the first device, the first indication information on the first PUSCH resource to the second device, wherein the first indication information is used to indicate whether to use a resource subsequent to the first PUSCH resource; or
the sending, by the first device, first indication information to the second device comprises at least one of following:
sending, by the first device, the first indication information on the one first PUSCH to the second device;
sending, by the first device, the first indication information on the plurality first PUSCHs to the second device;
sending, by the first device, the first indication information on each of the first PUSCH to the second device; or
sending, by the first device, the first indication information on a specific first PUSCH to the second device.

10. The apparatus according to claim 9, wherein
the resource subsequent to the first PUSCH resource is at least one of following:
a PUSCH resource in a third period;
a PUSCH resource in a configured PUSCH resource pattern;
a plurality of dynamically scheduled PUSCH resources;
a plurality of dynamically scheduled PUSCH resources subsequent to the first PUSCH resource;
PUSCH resources in a plurality of periods;
PUSCH resources in a plurality of configured PUSCH resource patterns;
PUSCH resources in a plurality of periods subsequent to the first PUSCH resource;
PUSCH resources in a plurality of configured PUSCH resource patterns subsequent to the first PUSCH resource;
a PUSCH resource that is subsequent to the first PUSCH resource and that is in a third period; or
a PUSCH resource that is subsequent to the first PUSCH resource and that is in a configured PUSCH resource pattern; or
the resource subsequent to the first PUSCH resource is at least one of following:
all of PUSCH resources subsequent to the first PUSCH resource;
at least one or a specific quantity of PUSCH resources subsequent to the first PUSCH resource;
one PUSCH resource subsequent to the first PUSCH resource;
a plurality of consecutive PUSCH resources subsequent to the first PUSCH resource; or
a plurality of inconsecutive PUSCH resources subsequent to the first PUSCH resource.

11. The apparatus according to claim 4, wherein
the first indication information is used to indicate at least one of following:
whether all of resources subsequent to the first PUSCH resource are to be used for data transmission;
whether each of resources subsequent to the first PUSCH resource is to be used for data transmission;
whether a plurality of resources subsequent to the first PUSCH resource are to be used for data transmission;
whether one of resources subsequent to the first PUSCH resource is to be used for data transmission;
a specific PUSCH resource in resources subsequent to the first PUSCH resource;
whether each of the target resource is to be used for data transmission;
whether one resource or one specific resource in the target resource is to be used for data transmission;
whether a plurality of resources or a plurality of specific resources in the target resource are to be used for data transmission; or
whether each of the target resource is to be used for data transmission; or
the first indication information is used to indicate at least one of following:
whether a next PUSCH following the first PUSCH is to be used for data transmission;
whether all PUSCHs in a CG period subsequent to the first PUSCH are to be used for data transmission;
whether all PUSCHs in a PUSCH resource pattern subsequent to the first PUSCH are to be used for data transmission; or
whether a PUSCH at a specified position subsequent to the first PUSCH is to be used for data transmission.

12. The apparatus according to claim 4, wherein there is one first PUSCH resource or there are a plurality of first PUSCH resources, and the first indication information is carried in the one first PUSCH resource or carried in the plurality of first PUSCH resources.

13. The apparatus according to claim 11, wherein the next PUSCH following the first PUSCH is a next PUSCH following the first PUSCH in terms of position, or a next PUSCH following the first PUSCH in terms of transmission order.

14. A data transmission apparatus, comprising a memory and a processor, wherein the memory is configured to store a program, and the processor is configured to invoke the program in the memory, to cause the data transmission apparatus to perform:
receiving, by a second device, indication information sent by a first device, wherein the first device is a user equipment (UE), the second device is a network device or a base station, the indication information is used to indicate whether to use a target resource for data transmission.

15. The apparatus according to claim 14, wherein
the indication information is used to indicate at least one of following:
at least one resource of the target resource is to be used for data transmission or is not to be terminated;
all resources of the target resource are to be used for data transmission or are not to be terminated;
at least one resource of the target resource is not to be used for data transmission or is to be terminated; or
all resources of the target resource are not to be used for data transmission or are to be terminated; or
the target resource is at least one of following:
a resource in a first period;
a resource in a second period subsequent to the first period;
a resource in a configured physical uplink shared channel (PUSCH) resource pattern;
a resource in one or more periods subsequent to the indication information;
a resource in one or more PUSCH resource patterns subsequent to the indication information;
one or more configured grant (CG) resources;
one or more CG resources in at least one period.

16. The apparatus according to claim 14, wherein the receiving, by a second device, indication information sent by a first device comprises at least one of following:
receiving, by the second device, first indication information sent by the first device, wherein the first indication information is sent together with a first PUSCH resource;
receiving, by the second device, second indication information sent by the first device, wherein the second indication information is sent before a second PUSCH resource;
receiving, by the second device, first indication information sent by the first device, wherein the first indication information is sent in a first CG period or in a first PUSCH resource pattern;
receiving, by the second device, second indication information sent by the first device, wherein the second indication information is sent in a second CG period or before a second PUSCH resource pattern.

17. The apparatus according to claim 16, wherein the first indication information is carried in:
CG uplink control information (CG-UCI).

18. The apparatus according to claim 14, wherein the method further comprises:
in a case that a first condition is met, generating the first indication information, and/or reporting the first indication information.

19. The apparatus according to claim 18, wherein the first condition comprises:
that CG-UCI is configured or activated.

20. The apparatus according to claim 16, wherein
there is one first PUSCH resource or there are a plurality of first PUSCH resources, and the first indication information is carried in the one first PUSCH resource or carried in the plurality of first PUSCH resources; or
the first indication information is used to indicate at least one of following:
whether a next PUSCH following the first PUSCH is to be used for data transmission;
whether all PUSCHs in a CG period subsequent to the first PUSCH are to be used for data transmission;
whether all PUSCHs in a PUSCH resource pattern subsequent to the first PUSCH are to be used for data transmission; or
whether a PUSCH at a specified position subsequent to the first PUSCH is to be used for data transmission.
